(19) United States
(12) Patent Application Publication
(10) Pub. No.: US 2023/0302787 A1
(43) Pub. Date: Sep. 28, 2023

(54) Liquid Discharge Apparatus And Capacitive Load Drive Circuit

(71) Applicant: SEIKO EPSON CORPORATION, Tokyo (JP)

(72) Inventors: Noritaka IDE, Shiojriri (JP); Kunio TABATA, Shiojiri (JP); Shoichiro YOKOO, Matsumoto (JP)

(21) Appl. No.: 18/187,699

(22) Filed: Mar. 22, 2023

(30) Foreign Application Priority Data
Mar. 23, 2022 (JP) 2022-046479

(51) Int. Cl. B41J 2/045

(52) U.S. Cl. CPC B41J 2/04541; B41J 2/04581; B41J 2/0455

(57) ABSTRACT

A liquid discharge apparatus includes a correction circuit that outputs a correction base drive signal obtained, a level shift circuit that outputs a level shift amplified modulation signal, and a demodulation circuit that outputs the drive signal by demodulating the level shift amplified modulation signal, the correction circuit outputs the correction base drive signal corrected by a first correction value, in a first mode in which the level shift circuit outputs the level shift amplified modulation signal having the reference potential of the amplified modulation signal as a first potential, and outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.

The present application is based on, and claims priority from JP Application Serial Number 2022-046479, filed Mar. 23, 2022, the disclosure of which is hereby incorporated by reference herein in its entirety.

### BACKGROUND

### 1. Technical Field

The present disclosure relates to a liquid discharge apparatus and a capacitive load drive circuit.

### 2. Related Art

As a liquid discharge apparatus that discharges a liquid to form an image or a document on a medium, a liquid discharge apparatus using a capacitive load such as a piezoelectric element is known. In such a liquid discharge apparatus, the capacitive load is provided corresponding to each of a plurality of nozzles that discharge the liquid, and each is driven according to a drive signal. By driving the capacitive load, the liquid is discharged from a nozzle provided corresponding to the capacitive load. It is necessary to supply a sufficient current in order to operate such a capacitive load. Therefore, a capacitive load drive circuit that outputs the drive signal for driving the capacitive load is configured to include an amplification circuit that amplifies a source signal on which the drive signal is based by the amplification circuit.

JP-A-2010-124040 discloses a drive circuit (capacitive load drive circuit) that outputs a drive signal for driving a piezoelectric element, which is one of the capacitive loads, includes a class D amplification circuit as an amplification circuit, and reduces power consumption for outputting a drive signal COM.

However, from the viewpoint of further improving a discharge accuracy of a liquid in a liquid discharge apparatus, and of further improving a waveform accuracy of a drive signal output by a capacitive load drive circuit, a technique described in JP-A-2010-124040 is not sufficient and there is room for improvement.

### SUMMARY

According to an aspect of the present disclosure, there is provided a liquid discharge apparatus including a liquid discharge head that includes a capacitive load driven by being supplied with a drive signal and discharges a liquid by driving the capacitive load, and a capacitive load drive circuit that outputs the drive signal, in which the capacitive load drive circuit includes a correction circuit that outputs a correction base drive signal obtained by correcting a base drive signal which is a base of the drive signal, a modulation circuit that outputs a modulation signal obtained by modulating the correction base drive signal, an amplification circuit that outputs an amplified modulation signal obtained by amplifying the modulation signal to a first output point, a level shift circuit that outputs a level shift amplified modulation signal obtained by level-shifting a reference potential of the amplified modulation signal to a second output point, a demodulation circuit that outputs the drive signal by demodulating the level shift amplified modulation signal, and a feedback circuit that feeds back the drive signal to the correction circuit, and the correction circuit outputs the correction base drive signal corrected by a first correction value, in a first mode in which the level shift circuit outputs the level shift amplified modulation signal having the reference potential of the amplified modulation signal as a first potential, and outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.

According to still another aspect of the present disclosure, there is provided a capacitive load drive circuit that includes a capacitive load to be driven by being supplied with a drive signal and outputs the drive signal to a liquid discharge head which discharges a liquid by driving the capacitive load, the circuit including a correction circuit that outputs a correction base drive signal obtained by correcting a base drive signal which is a base of the drive signal, a modulation circuit that outputs a modulation signal obtained by modulating the correction base drive signal, an amplification circuit that outputs an amplified modulation signal obtained by amplifying the modulation signal to a first output point, a level shift circuit that outputs a level shift amplified modulation signal obtained by level-shifting a reference potential of the amplified modulation signal to a second output point, a demodulation circuit that outputs the drive signal by demodulating the level shift amplified modulation signal, and a feedback circuit that feeds back the drive signal to the correction circuit, in which the correction circuit outputs the correction base drive signal corrected by a first correction value, in a first mode in which the level shift circuit outputs the level shift amplified modulation signal having the reference potential of the amplified modulation signal as a first potential, and outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.

### BRIEF DESCRIPTION OF THE DRAWINGS

FIG. 1 is a view illustrating an example of a structure of a liquid discharge apparatus.

FIG. 2 is a diagram illustrating an example of a functional configuration of the liquid discharge apparatus.

FIG. 3 is a diagram illustrating an example of arrangement of a plurality of discharge portions in a head unit.

FIG. 4 is a diagram illustrating an example of a configuration of a discharge portion.

FIG. 5 is a graph illustrating an example of a signal waveform of a drive signal.

FIG. 6 is a diagram illustrating an example of a configuration of a drive signal selection circuit.

FIG. 7 is a table illustrating an example of a decoding content in a decoder.

FIG. 8 is a diagram illustrating an example of a configuration of a selection circuit.

FIG. 9 is a diagram for describing an operation of the drive signal selection circuit.

FIGS. 10A and 10B are diagrams illustrating an example of a functional configuration of a drive circuit.

FIG. 11 is a graph for describing a relationship between a correction base drive signal and a modulation signal.

FIG. 12 is a graph for describing a relationship between a base drive signal and a reference level switching signal.

FIGS. 13A and 13B are diagrams illustrating an example of a functional configuration of a drive circuit according to a second embodiment.

FIGS. 14A and 14B are diagrams illustrating an example of a functional configuration of a drive circuit according to a third embodiment.

FIGS. 15A and 15B are diagrams illustrating an example of a functional configuration of a drive circuit according to a fourth embodiment.

### DESCRIPTION OF EXEMPLARY EMBODIMENTS

Hereinafter, preferred embodiments of the present disclosure will be described with reference to the drawings. The drawings used are for convenience of description. The embodiments described below do not unreasonably limit the content of the present disclosure described in the aspects. In addition, not all of the configurations described below are essential constituent requirements of the present disclosure.

In the following description, an ink jet printer for a consumer is used as an example of a liquid discharge apparatus according to the present disclosure. However, the liquid discharge apparatus is not limited to an ink jet printer for a consumer, and may be, for example, a coloring material discharge apparatus used for manufacturing a color filter such as a liquid crystal display, an electrode material discharge apparatus used for forming an electrode such as an organic EL display and a surface emission display, and a bioorganic substance discharge apparatus used for manufacturing a biochip.

### 1. First Embodiment

### 1.1 Configuration of Liquid Discharge Apparatus

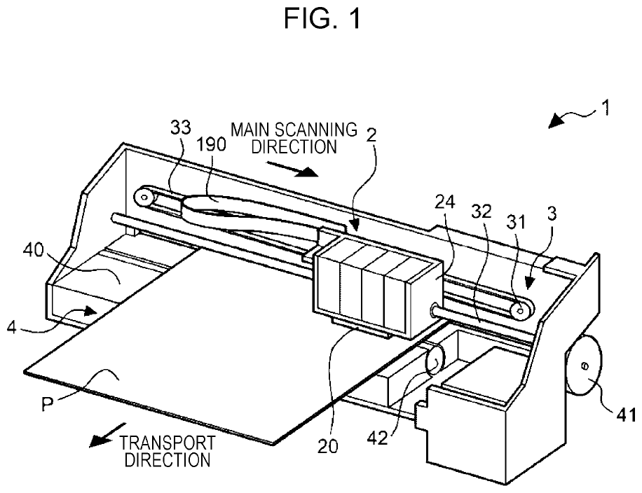

FIG. 1 is a view illustrating an example of a structure of a liquid discharge apparatus 1. As illustrated in FIG. 1, the liquid discharge apparatus 1 is provided with a moving object 2 and a moving unit 3 that reciprocates the moving object 2 along the main scanning direction.

The moving unit 3 includes a carriage motor 31 that serves as a drive source for reciprocating movement of the moving object 2 along the main scanning direction, a carriage guide shaft 32 that has both ends fixed, and a timing belt 33 that extends substantially parallel to the carriage guide shaft 32 and is driven by the carriage motor 31.

The moving object 2 includes a carriage 24. The carriage 24 is supported by the carriage guide shaft 32 so as to be able to reciprocate and is fixed to a portion of the timing belt 33. The timing belt 33 travels forward and rearward by the carriage motor 31, so that the moving object 2 having the carriage 24 is guided by the carriage guide shaft 32 to reciprocate. In addition, a head unit 20 is located in a portion of the moving object 2 facing a medium P. That is, the head unit 20 is mounted on the carriage 24. Multiple nozzles that discharge an ink as a liquid are located on a surface of the head unit 20 facing the medium P. In addition, various control signals for controlling the operation of the head unit 20 are supplied to the head unit 20 via a cable 190. As such a cable 190, a flexible flat cable or the like that can slide following the reciprocating movement of the moving object 2 can be used.

In addition, the liquid discharge apparatus 1 is provided with a transport unit 4 for transporting the medium P on a platen 40 along a transport direction. The transport unit 4 includes a transport motor 41 that is a drive source for transporting the medium P, and a transport roller 42 that transports the medium P along the transport direction by being rotated by the transport motor 41.

In the liquid discharge apparatus 1 configured as described above, the head unit 20 discharges the ink on the medium P in synchronization with the timing when the medium P is transported by the transport unit 4. As a result, the ink discharged by the head unit 20 lands at a desired position on the medium P, and as a result, a desired image or character is formed on the surface of the medium P.

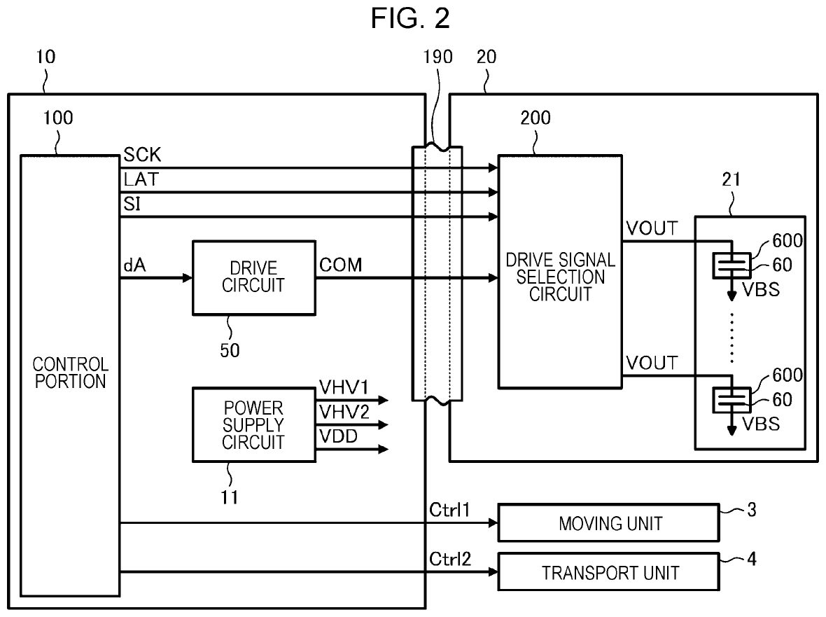

Next, a functional configuration of the liquid discharge apparatus 1 will be described. FIG. 2 is a diagram illustrating an example of the functional configuration of the liquid discharge apparatus 1. As illustrated in FIG. 2, the liquid discharge apparatus 1 is provided with a control unit 10, a head unit 20, a moving unit 3, a transport unit 4, and a cable 190. The cable 190 electrically couples the control unit 10 and the head unit 20.

The control unit 10 includes a power supply circuit 11, a control portion 100, and a drive circuit 50.

The power supply circuit 11 generates voltage signals VHV1, VHV2, and VDD having a predetermined voltage value from a commercial AC power supply supplied from the outside of the liquid discharge apparatus 1, and outputs the voltage signals to the various components of the liquid discharge apparatus 1. Here, the voltage signals VHV1 and VHV2 output by the power supply circuit 11 are, for example, a DC voltage of 25 V, and the voltage signal VDD is, for example, a DC voltage of 3.3 V. Such a power supply circuit 11 may include, for example, an AC/DC converter that generates a DC voltage having a predetermined voltage value from a commercial AC power supply, and a DC/DC converter that converts the voltage value of the generated DC voltage to generate voltage signals VHV1, VHV2, and VDD. The power supply circuit 11 may output DC voltages having different voltage values in addition to the voltage signals VHV1, VHV2, and VDD.

An image data is supplied to the control portion 100 from an external device (not illustrated) provided outside the liquid discharge apparatus 1, for example, from a host computer or the like. The control portion 100 generates various control signals for controlling each part of the liquid discharge apparatus 1 by performing various image processing and the like on the supplied image data, and outputs the various control signals to the corresponding configurations.

Specifically, the control portion 100 generates a control signal Ctrl1 for controlling the reciprocating movement of the moving object 2 and outputs the control signal Ctrl1 to the carriage motor 31 included in the moving unit 3. In addition, the control portion 100 generates a control signal Ctrl2 for controlling the transport of the medium P, and outputs the control signal Ctrl2 to the transport motor 41 included in the transport unit 4. As a result, the reciprocating movement of the moving object 2 along the main scanning direction and the transport of the medium P along the transport direction are controlled by the control portion 100. As a result, the head unit 20 can discharge the ink on the medium P at a predetermined timing synchronized with the transport of the medium P. As a result, the ink lands at a desired position on the medium P, and a desired image or character can be formed on the medium P.

The control portion 100 may supply the control signal Ctrl1 for controlling the reciprocating movement of the moving object 2 to the moving unit 3 via a carriage motor driver (not illustrated). Similarly, the control portion 100 may supply the control signal Ctrl2 for controlling the transport of the medium P to the transport unit 4 via a transport motor driver (not illustrated).

In addition, the control portion 100 outputs a base drive signal dA to the drive circuit 50. The base drive signal dA output by the control portion 100 is a signal including data defining a waveform of the drive signal COM supplied to the head unit 20, and is, for example, a digital signal. The drive circuit 50 converts the input digital base drive signal dA into an analog signal, and then amplifies the converted signal to generate a drive signal COM. The drive circuit 50 supplies the generated drive signal COM to the head unit 20. The details of the configuration and operation of the drive circuit 50 will be described later.

In addition, the control portion 100 generates a clock signal SCK, a latch signal LAT, and a print data signal SI for controlling the operation of the head unit 20, and outputs these signals to the head unit 20.

The head unit 20 includes a drive signal selection circuit 200 and a liquid discharge head 21. In addition, the liquid discharge head 21 includes a plurality of discharge portions 600, and each of the plurality of discharge portions 600 includes a piezoelectric element 60. In the following description, the number of discharge portions 600 included in the liquid discharge head 21 may be described as n.

The clock signal SCK, the latch signal LAT, and the print data signal SI are input to the drive signal selection circuit 200. The drive signal selection circuit 200 switches whether or not to supply the drive signal COM as the drive signal VOUT to one end of the piezoelectric element 60 included in each of the plurality of discharge portions 600 in a period defined by the latch signal LAT based on the print data signal SI propagated by the clock signal SCK.

In addition, a reference voltage signal VBS is supplied to the other end of the piezoelectric element 60 included in each of the plurality of discharge portions 600. The reference voltage signal VBS is a signal that functions as a reference potential for driving the piezoelectric element 60 driven by the drive signal VOUT, and is, for example, a signal having a constant potential such as 5.5 V, 6 V, or a ground potential.

The piezoelectric element 60 is driven according to the potential difference between the drive signal VOUT supplied to one end and the reference voltage signal VBS supplied to the other end. By driving the piezoelectric element 60, ink is discharged from the discharge portion 600 including the piezoelectric element 60.

Although FIG. 2 illustrates when the head unit 20 has one liquid discharge head 21, the number of liquid discharge heads 21 included in the head unit 20 is not limited to one, and the head unit 20 may have a plurality of liquid discharge heads 21 according to the type and number of inks to be discharged.

As described above, the liquid discharge apparatus 1 in the present embodiment is provided with a plurality of piezoelectric elements 60 that are driven by being supplied with the drive signals COM and VOUT, the liquid discharge head 21 that discharges ink as an example of liquid by driving the plurality of piezoelectric elements 60, and the drive circuit 50 that outputs the drive signal COM.

### 1.2 Configuration and Operation of Discharge Portion

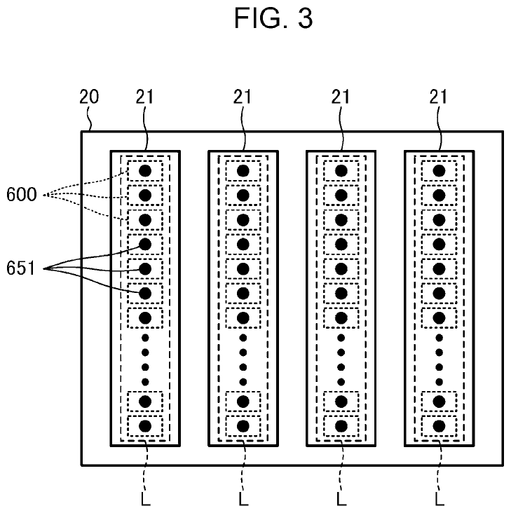

Next, a configuration of the plurality of discharge portions 600 included in the head unit 20 and an example of arrangement of the plurality of discharge portions 600 in the head unit 20 will be described. FIG. 3 is a diagram illustrating an example of arrangement of the plurality of discharge portions 600 in the head unit 20. FIG. 3 illustrates when the head unit 20 includes four liquid discharge heads 21.

As illustrated in FIG. 3, each of the four liquid discharge heads 21 includes the plurality of discharge portions 600 provided in a row in one direction. That is, the liquid discharge head 21 includes a nozzle row L in which nozzles 651, which will be described later, included in the discharge portion 600 are arranged in one direction. In addition, the liquid discharge heads 21 are located side by side in the head unit 20 in a direction intersecting the nozzle row L. That is, the head unit 20 is formed with the same number of nozzle rows L as the number of liquid discharge heads 21. The arrangement of the nozzles 651 in the nozzle row L included in the liquid discharge head 21 is not limited to one row, and for example, even-numbered nozzles 651 counted from one end portion of the plurality of nozzles 651 and odd-numbered nozzles 651 counted from one end portion of the plurality of nozzles 651 may be arranged in a staggered manner so that the positions of the nozzles 651 are different. In the liquid discharge head 21, one nozzle row L may be formed by arranging the plurality of nozzles 651 in two or more rows.

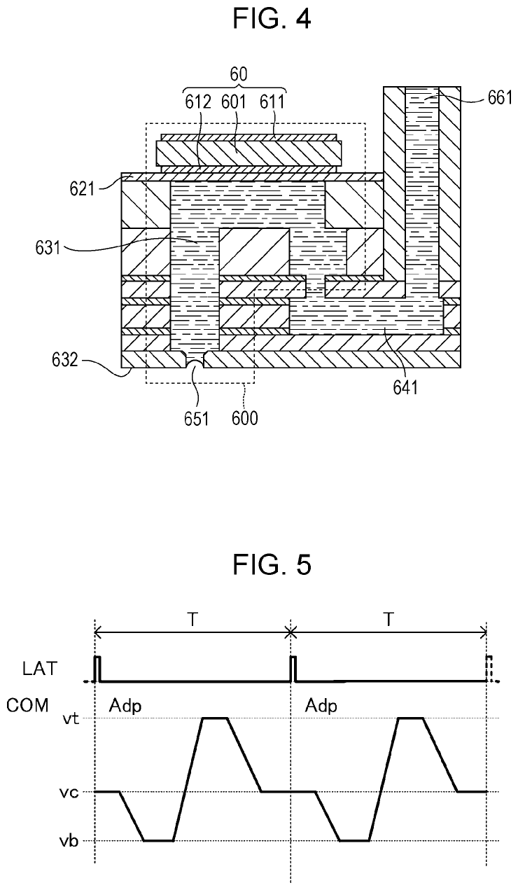

Next, an example of a configuration of the discharge portion 600 will be described. FIG. 4 is a diagram illustrating an example of the configuration of the discharge portion 600. As illustrated in FIG. 4, the discharge portion 600 includes a piezoelectric element 60, a diaphragm 621, a cavity 631, and a nozzle 651. The diaphragm 621 is displaced as the piezoelectric element 60 provided on the upper surface in FIG. 4 is driven. That is, the diaphragm 621 functions as a diaphragm that expands/contracts the internal volume of the cavity 631. The inside of the cavity 631 is filled with ink. The cavity 631 functions as a pressure chamber in which internal volume changes due to displacement of the diaphragm 621 due to driving of the piezoelectric element 60. The nozzle 651 is an opening portion formed in the nozzle plate 632 and communicating with the cavity 631. As the internal volume of the cavity 631 changes, the ink stored inside the cavity 631 is discharged from the nozzle 651.

The piezoelectric element 60 has a structure in which a piezoelectric body 601 is interposed between a pair of electrodes 611 and 612. In the piezoelectric body 601 having this structure, the electrodes 611 and 612 and the central portion of the diaphragm 621 are bent in the vertical direction in FIG. 4 with respect to both end portions according to a potential difference between the electrodes 611 and 612.

Specifically, the drive signal VOUT is supplied to the electrode 611, which is one end of the piezoelectric element 60, and the reference voltage signal VBS is supplied to the electrode 612, which is the other end. When the piezoelectric element 60 is driven upward in response to a change in the voltage value of the drive signal VOUT, the diaphragm 621 is displaced upward. As a result, the internal volume of the cavity 631 is increased. Therefore, the ink stored in a reservoir 641 is drawn into the cavity 631. On the other hand, when the piezoelectric element 60 is driven downward in response to a change in the voltage value of the drive signal VOUT, the diaphragm 621 is displaced downward. As a result, the internal volume of the cavity 631 is reduced. Therefore, an amount of ink corresponding to the degree of reduction in the internal volume of the cavity 631 is discharged from the nozzle 651.

As described above, the liquid discharge head 21 includes the piezoelectric element 60, and discharges ink on the medium by driving the piezoelectric element 60. The discharge portion 600 and the piezoelectric element 60 included in the discharge portion 600 are not limited to the illustrated configuration, and may have a structure in which the piezoelectric element 60 is driven based on the drive signal VOUT and ink can be discharged from the corresponding nozzle 651 by driving the piezoelectric element 60.

### 1.3 Configuration and Operation of Selection Control Circuit

Next, the configuration and operation of the drive signal selection circuit 200 will be described. As described above, the drive signal selection circuit 200 switches whether or not to supply the drive signal VOUT based on the drive signal COM to the piezoelectric element 60 included in each of the plurality of discharge portions 600 based on the clock signal SCK, the latch signal LAT, and the print data signal SI. Therefore, in describing the configuration and operation of the drive signal selection circuit 200, first, an example of a signal waveform of the drive signal COM supplied to the drive signal selection circuit 200 will be described.

FIG. 5 is a graph illustrating an example of the signal waveform of the drive signal COM. As illustrated in FIG. 5, the drive signal COM includes a trapezoidal waveform Adp for each cycle T from when the latch signal LAT rises to when the latch signal LAT next rises. The trapezoidal waveform Adp includes a constant period at voltage vc, a constant period at voltage vb, which has a lower voltage value than voltage vc, following the constant period at voltage vc, a constant period at voltage vt, which has a higher voltage value than voltage vc, following the constant period at voltage vb, and a constant period at voltage vc, following a constant period at voltage vt. That is, the drive signal COM includes a trapezoidal waveform Adp that starts at a voltage vc and ends at a voltage vc.

The voltage vc corresponds to a potential that is a reference for the displacement of the piezoelectric element 60. The voltage value of the drive signal COM supplied to the piezoelectric element 60 changes from the voltage vc to the voltage vb, so that the piezoelectric element 60 is driven upward as illustrated in FIG. 4. As a result, the diaphragm 621 is displaced upward as illustrated in FIG. 4. The diaphragm 621 is displaced upward as illustrated in FIG. 4, so that the internal volume of the cavity 631 expands, and ink is drawn from the reservoir 641 into the cavity 631. Thereafter, the voltage value of the drive signal COM supplied to the piezoelectric element 60 changes from the voltage vb to the voltage vt, so that the piezoelectric element 60 is driven downward as illustrated in FIG. 4. As a result, the diaphragm 621 is displaced downward as illustrated in FIG. 4. The diaphragm 621 is displaced downward as illustrated in FIG. 4, so that the internal volume of the cavity 631 is reduced, and the ink stored in the cavity 631 is discharged from the nozzle 651.

In addition, for a certain period of time after the ink is discharged from the nozzle 651 by driving the piezoelectric element 60, the ink in the vicinity of the nozzle 651 or the diaphragm 621 may continue to vibrate. The certain period at the voltage vc included in the drive signal COM also functions as a period for stopping the vibration not contributing to the discharge of such an ink or the ink generated in the diaphragm 621.

Here, the signal waveform of the drive signal COM illustrated in FIG. 5 is an example, is not limited thereto, and may include various shapes of signal waveforms according to the physical properties of the ink discharged by the liquid discharge head 21, the length of the cycle T of the drive signal COM, the transport speed of the medium P, and the like.

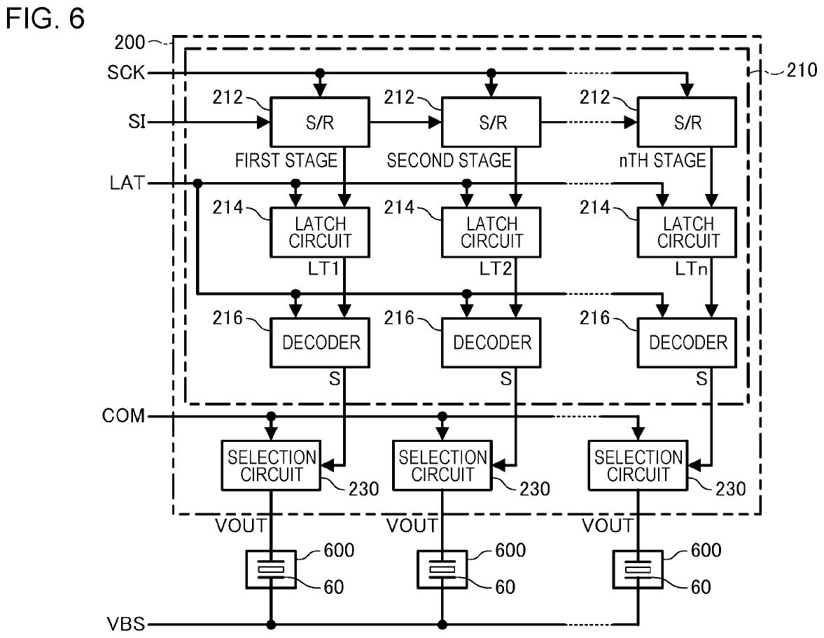

Next, the configuration and operation of the drive signal selection circuit 200 that generates the drive signal VOUT by selecting or not selecting the signal waveform included in the drive signal COM will be described. FIG. 6 is a diagram illustrating an example of the configuration of the drive signal selection circuit 200. As illustrated in FIG. 6, the drive signal selection circuit 200 includes a selection control circuit 210 and n selection circuits 230.

The clock signal SCK, the print data signal SI, and the latch signal LAT are input to the selection control circuit 210. In addition, the selection control circuit 210 includes a set of a shift register (S/R) 212, a latch circuit 214, and a decoder 216 corresponding to each of the n discharge portions 600. That is, the drive signal selection circuit 200 includes n shift registers 212, n latch circuits 214, and n decoders 216.

The print data signal SI is input to the selection control circuit 210 in synchronization with the clock signal SCK. The print data signal SI serially includes print data [SId] for selecting “discharge FD” in which dots are formed on the medium P by discharging ink from the discharge portion 600, and “non-discharge ND” in which dots are not formed on the medium P by not discharging ink from the discharge portion 600 corresponding to each of the n discharge portions 600. That is, the print data signal SI is a serial signal of n bits or more.

The print data [SId] included in the print data signal SI is held in n shift registers 212 corresponding to n discharge portions 600. Specifically, n shift registers 212 corresponding to the discharge portion 600 are vertically coupled to each other, and the serially input print data signal SI is sequentially transferred to the subsequent shift register 212 according to the clock signal SCK. The print data [SId] is held in the corresponding shift register 212, so that the supply of the clock signal SCK is stopped. In other words, when the supply of the clock signal SCK is stopped, the print data [SId] included in the print data signal SI is held in the corresponding shift register 212. In FIG. 6, in order to distinguish the n shift registers 212, the shift registers are expressed as a first stage, a second stage, . . . , and an nth stage in order from the upstream to the downstream where the print data signal SI is input.

Each of the n latch circuits 214 latches simultaneously the print data [SId] held in the corresponding shift register 212 when the latch signal LAT rises. The print data [SId] latched by the latch circuit 214 is input to the corresponding decoder 216.

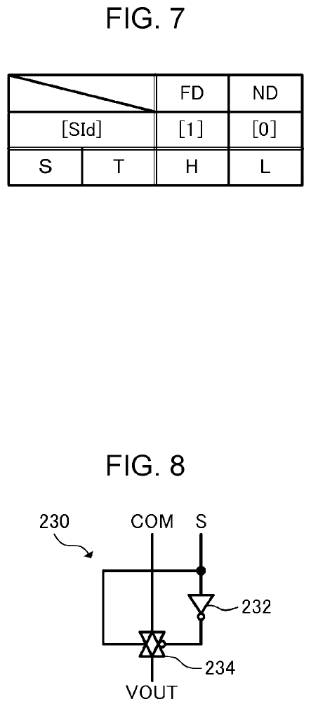

FIG. 7 is a table illustrating an example of the decoding content in the decoder 216. The decoder 216 outputs a selection signal S at a logic level corresponding to the input print data [SId]. Specifically, when the print data [SId]=[1] is input to the decoder 216, the decoder 216 outputs an H level selection signal S in the cycle T, and when the print data [SId]=[0] is input to the decoder 216, the decoder 216 outputs the L level selection signal S in the cycle T.

The selection signal S output by the decoder 216 is input to the selection circuit 230. The selection circuit 230 is provided corresponding to each of the n discharge portions 600. That is, the drive signal selection circuit 200 includes n selection circuits 230, which is the same number as the n discharge portions 600. FIG. 8 is a diagram illustrating an example of a configuration of the selection circuit 230 corresponding to one discharge portion 600. As illustrated in FIG. 8, the selection circuit 230 includes an inverter 232 which is NOT circuit and a transfer gate 234.

The selection signal S is input to a positive control terminal not marked with a circle in the transfer gate 234, and is also input to the negative control terminal marked with a circle in the transfer gate 234 after the logic level is inverted by the inverter 232. In addition, the drive signal COM is supplied to the input terminal of the transfer gate 234. When the H level selection signal S is input, the transfer gate 234 is conductive between the input terminal and the output terminal, and when the L level selection signal S is input, the transfer gate 234 is non-conductive between the input terminal and the output terminal. That is, when the logic level of the input selection signal S is H level, the transfer gate 234 outputs the trapezoidal waveform Adp from the output terminal, and when the logic level of the input selection signal S is L level, the transfer gate 234 does not output the trapezoidal waveform Adp from the output terminal. The signal output to the output terminal of the transfer gate 234 included in the selection circuit 230 is output from the drive signal selection circuit 200 as the drive signal VOUT.

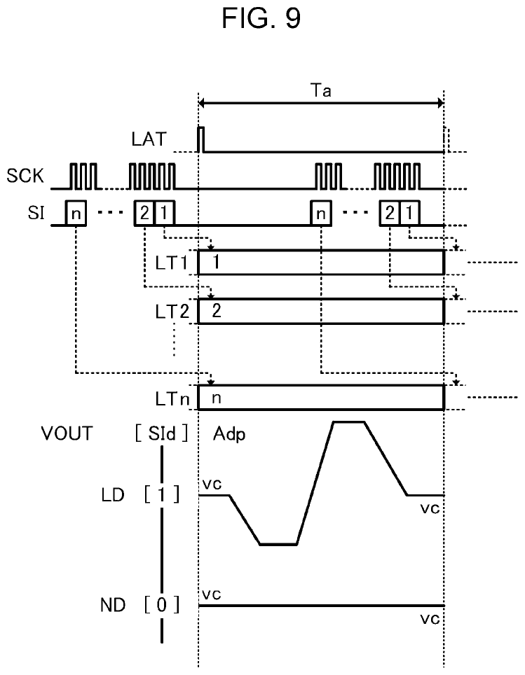

Here, the operation of the drive signal selection circuit 200 will be described with reference to FIG. 9. FIG. 9 is a diagram for describing the operation of the drive signal selection circuit 200. The print data signal SI is input to the selection control circuit 210 as a serial signal synchronized with the clock signal SCK. The print data signal SI is sequentially transferred in the n shift registers 212 corresponding to the n discharge portions 600 in synchronization with the clock signal SCK. Thereafter, when the input of the clock signal SCK is stopped, the print data [SId] corresponding to each of the n discharge portions 600 is held in the shift register 212. The print data signal SI includes the print data [SId] in the order corresponding to the discharge portions 600 of the nth stage, . . . , the second stage, and the first stage of the shift register 212.

When the latch signal LAT rises, each of the latch circuits 214 latches simultaneously the print data [SId] held in the shift register 212. The print data [SId] latched by the latch circuit 214 is input to the corresponding decoder 216. The LT1, LT2, . . . , LTn illustrated in FIG. 9 correspond to the print data [SId] latched by the latch circuit 214 corresponding to the shift register 212 of the first stage, the second stage, . . . , and the nth stage.

The decoder 216 generates the selection signal S at the logic level illustrated in FIG. 7 by decoding the input print data [SId] and outputs the selection signal S to the corresponding selection circuit 230. The selection circuit 230 selects or does not select the trapezoidal waveform Adp included in the drive signal COM according to the logic level of the selection signal S output by the decoder 216, so that the selection circuit 230 generates a drive signal VOUT corresponding to each of the n discharge portions 600 and outputs the drive signal VOUT to the corresponding discharge portion 600.

Specifically, when the print data [SId]=[1] is input to the decoder 216, the decoder 216 outputs the H level selection signal S in the cycle T. As a result, the selection circuit 230 selects and outputs the trapezoidal waveform Adp in the cycle T. That is, the drive signal selection circuit 200 supplies the drive signal VOUT corresponding to the “discharge FD” to the piezoelectric element 60 of the discharge portion 600. As a result, an amount of ink corresponding to the drive signal VOUT is discharged from the corresponding discharge portion 600. The ink discharged from the discharge portion 600 lands on the medium P, so that dots are formed on the medium P.

On the other hand, when the print data [SId]=[0] is input to the decoder 216, the decoder 216 outputs the L level selection signal S in the cycle T. As a result, the selection circuit 230 does not select the trapezoidal waveform Adp in the cycle T. At this time, the electrode 611 of the piezoelectric element 60 corresponding to the selection circuit 230 holds the voltage vc due to the capacitance component of the piezoelectric element 60. That is, the drive signal selection circuit 200 supplies the voltage vc held immediately before due to the capacitance component of the corresponding piezoelectric element 60 to the piezoelectric element 60 as the drive signal VOUT corresponding to the “non-discharge ND”. As a result, the ink is not discharged from the corresponding discharge portion 600, and thus no dots are formed on the medium P.

As described above, the drive signal selection circuit 200 switches the supply of the drive signal COM to the plurality of piezoelectric elements 60 based on the print data signal SI.

### 1.4. Configuration and Operation of Drive Circuit

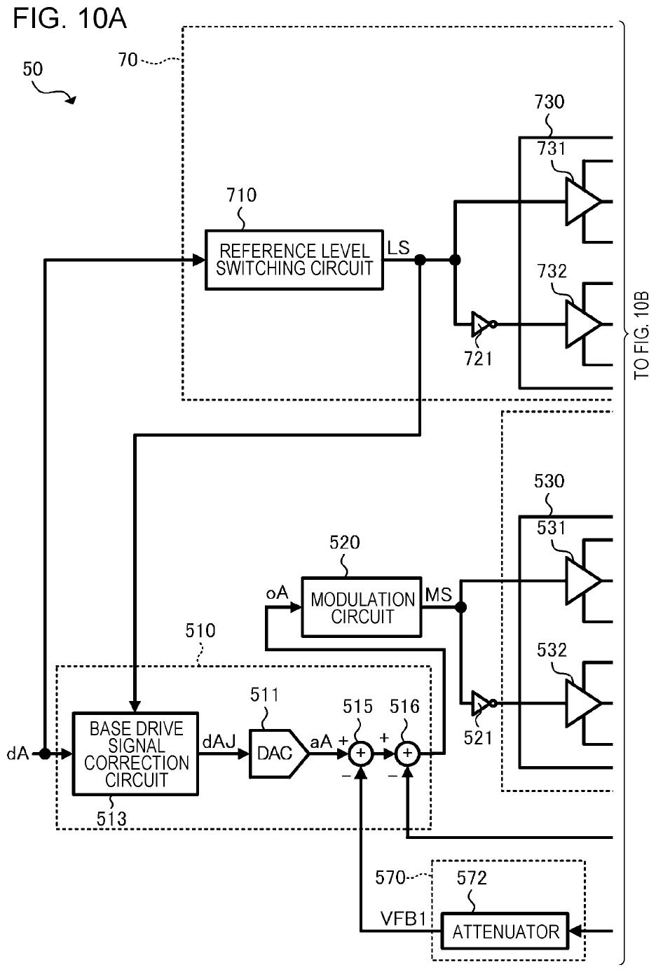

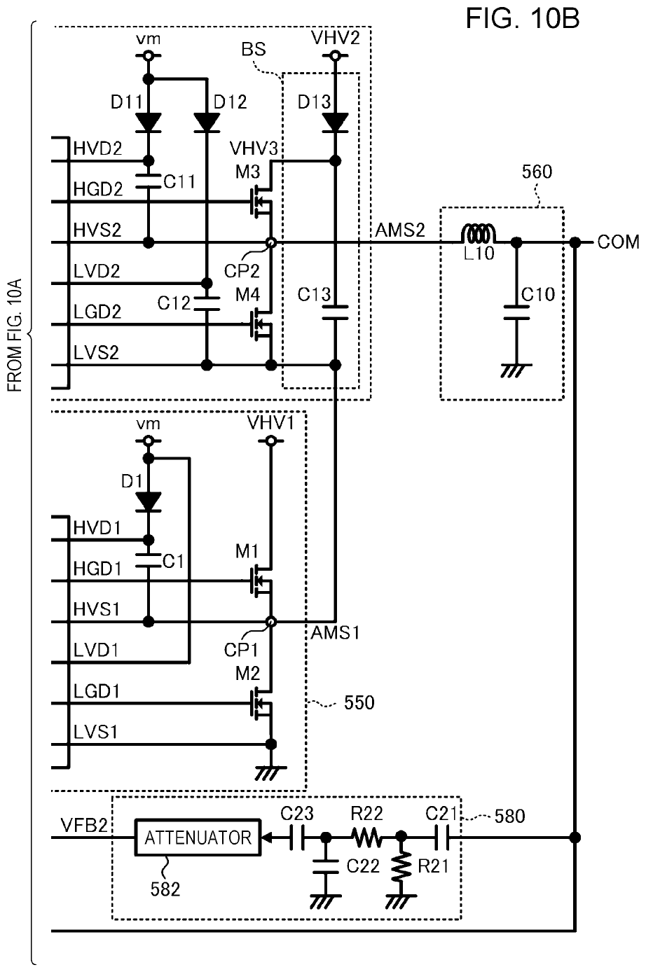

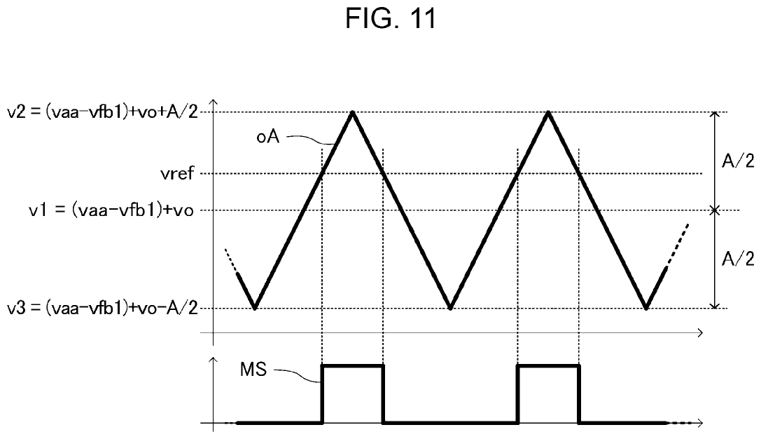

Next, the configuration and operation of the drive circuit 50 that generates and outputs the drive signal COM will be described. FIGS. 10A and 10B are diagrams illustrating an example of the functional configuration of the drive circuit 50. As illustrated in FIGS. 10A and 10B, the drive circuit 50 includes a correction circuit 510, a modulation circuit 520, an amplification circuit 550, a demodulation circuit 560, a first feedback circuit 570, a second feedback circuit 580, and a level shift circuit 70.

The base drive signal dA, which is a digital signal, is input from the control portion 100 to the correction circuit 510. The correction circuit 510 digital-analog converts and corrects the input base drive signal dA to generate and output a correction base drive signal oA. Such a correction circuit 510 includes a base drive signal correction circuit 513, a digital to analog converter (DAC) 511, and adders 515 and 516.

The base drive signal dA and the reference level switching signal LS from the level shift circuit 70, which will be described later, are input to the base drive signal correction circuit 513. The base drive signal correction circuit 513 subtracts a predetermined correction value from the base drive signal dA according to the logic level of the input reference level switching signal LS, and outputs the subtracted value as a correction signal dAJ. Specifically, when the L level reference level switching signal LS is input, the base drive signal correction circuit 513 subtracts a predetermined correction value Cv1 from the base drive signal dA, outputs the subtracted value as a correction signal dAJ. When the H level reference level switching signal LS is input, the base drive signal correction circuit 513 subtracts a predetermined correction value Cv2 from the base drive signal dA and outputs the subtracted value as a correction signal dAJ.

Here, in the following description, it is assumed that the correction value Cv1 is “0” and the correction value Cv2 is any one of natural numbers. That is, it will be described that the base drive signal correction circuit 513 according to the present embodiment outputs the base drive signal dA as the correction signal dAJ when the L level reference level switching signal LS is input, and subtracts a value defined by a predetermined correction value Cv2 from the base drive signal dA, and outputs the subtracted value as a correction signal dAJ, when the H level reference level switching signal LS is input. Each of the correction values Cv1 and Cv2 are not limited thereto, and any value can be used.

The correction signal dAJ is input to the DAC circuit 511. The DAC circuit 511 generates and outputs a base drive signal aA of an analog signal by digital-analog converting the input correction signal dAJ.

The base drive signal aA is input to the input terminal on the + side of the adder 515, and the first feedback signal VFB1 is input to the input terminal on the − side of the adder 515. The adder 515 outputs a signal obtained by subtracting the first feedback signal VFB1 from the base drive signal aA. Here, the first feedback signal VFB1 input to the adder 515 is a signal obtained by feeding back the drive signal COM via the first feedback circuit 570, and specifically, a signal obtained by attenuating the voltage value of the drive signal COM by an attenuator 572.

A signal output by the adder 515 is input to the input terminal on the + side of the adder 516, and a second feedback signal VFB2 is input to the input terminal on the − side of the adder 516. The adder 516 outputs a signal obtained by subtracting the second feedback signal VFB2 from the signal output by the adder 515 as the correction base drive signal oA. Here, the second feedback signal VFB2 is a signal obtained by feeding back the drive signal COM via the second feedback circuit 580, and specifically, a signal obtained by attenuating the voltage value of the signal of the high frequency component included in the drive signal COM by an attenuator 582.

As described above, the correction circuit 510 generates and outputs a correction base drive signal oA by correcting the input base drive signal dA based on the correction value Cv1 or the correction value Cv2, the first feedback signal VFB1, and the second feedback signal VFB2. That is, the correction circuit 510 outputs the correction base drive signal oA obtained by correcting the base drive signal dA which is a base of the drive signal COM.

The modulation circuit 520 includes, for example, a comparator. The modulation circuit 520 outputs a modulation signal MS obtained by pulse-modulating the correction base drive signal oA. Specifically, the modulation circuit 520 compares the voltage value of the correction base drive signal oA with the voltage vref of a predetermined voltage value which is a reference voltage. The modulation circuit 520 generates and outputs the modulation signal MS that is H level when the voltage value of the input correction base drive signal oA is higher than the voltage vref, and is L level when the voltage value of the correction base drive signal oA is lower than the voltage vref.

The amplification circuit 550 includes a gate drive circuit 530, a diode D1, a capacitor C1, and transistors M1 and M2. The amplification circuit 550 outputs an amplified modulation signal AMS1 that amplifies the modulation signal MS from a midpoint CP1.

Specifically, the modulation signal MS is input to the gate driver 531 included in the gate drive circuit 530. The gate driver 531 generates and outputs a gate signal HGD1 obtained by level-shifting the input modulation signal MS. In addition, the modulation signal MS is input to the gate driver 532 included in the gate drive circuit 530 after the logic level is inverted in the inverter 521. The gate driver 532 generates and outputs a gate signal LGD1 obtained by level-shifting a signal in which the logic level of the input modulation signal MS is inverted.

The transistors M1 and M2 are both configured to include N-channel MOS-FETs. The gate signal HGD1 output by the gate driver 531 is input to a gate terminal of the transistor M1. The voltage signal VHV1 is supplied to a drain terminal of the transistor M1. A source terminal of the transistor M1 is electrically coupled to the midpoint CP1. In addition, the gate signal LGD1 output by the gate driver 532 is input to a gate terminal of the transistor M2. The drain terminal of the transistor M2 is electrically coupled to the midpoint CP1. A ground potential is supplied to the source terminal of the transistor M2. The transistor M1 operates based on the gate signal HGD1 and the transistor M2 operates based on the gate signal LGD1. Therefore, an amplified modulation signal AMS1 obtained by amplifying the modulation signal MS with the voltage signal VHV1, is generated at a midpoint CP1 where the transistor M1 and the transistor M2 are coupled.

Here, the operation of the gate drive circuit 530 that outputs the gate signal HGD1 and the gate signal LGD1 based on the modulation signal MS will be described. The gate drive circuit 530 includes gate drivers 531, and 532. As described above, the modulation signal MS is input to the gate driver 531 and a signal in which the logic level of the modulation signal MS is inverted by the inverter 521 is input to the gate driver 532. That is, the signal input to the gate driver 531 and the signal input to the gate driver 532 are exclusively at the H level. Here, being H level exclusively includes the fact that the H level signals are not simultaneously input to the gate driver 531 and the gate driver 532. That is, the case where the L level signals are simultaneously input to the gate driver 531 and the gate driver 532 is not excluded.

A power supply terminal of the gate driver 531 on the low potential side is electrically coupled to the midpoint CP1. Therefore, the signal generated at the midpoint CP1 is supplied as a voltage signal HVS1 to the power supply terminal of the gate driver 531 on the low potential side. In addition, the power supply terminal of the gate driver 531 on the high potential side is electrically coupled to the cathode terminal of the diode D1 and one end of the capacitor C1. In addition, a voltage vm is supplied to the anode terminal of the diode D1, and the other end of the capacitor C1 is electrically coupled to the midpoint CP1. That is, the output of the bootstrap circuit including the diode D1 and the capacitor C1 is supplied to the power supply terminal on the high potential side of the gate driver 531. As a result, a voltage signal HVD1 having a voltage value higher than the voltage signal HVS1 by a voltage vm input to the power supply terminal of the gate driver 531 on the low potential side is supplied to the power supply terminal of the gate driver 531 on the high potential side. Therefore, when the H level modulation signal MS is input to the gate driver 531, the gate driver 531 outputs the gate signal HGD1 having a voltage value based on the voltage signal HVD1 which is higher than the voltage value of the midpoint CP1 by a voltage vm. When the L level modulation signal MS is input to the gate driver 531, the gate driver 531 outputs the gate signal HGD1 having a voltage value based on the voltage signal HVS1 which is the voltage value of the midpoint CP1.

Here, the voltage vm is a voltage value capable of driving each of the transistors M1, M2, M3, and M4, and is, for example, a DC voltage of 7.5 V. The voltage vm may be generated, for example, by stepping down or boosting the voltage signals VHV1, VHV2, and VDD output by the power supply circuit 11.

A ground potential signal is supplied to the power supply terminal of the gate driver 532 on the low potential side as a voltage signal LVS1. In addition, the voltage vm is supplied to the power supply terminal of the gate driver 532 on the high potential side as a voltage signal LVD1. Therefore, when an H level signal in which the logic level of the L level modulation signal MS is inverted by the inverter 521 is input to the gate driver 532, the gate driver 532 outputs the gate signal LGD1 having a voltage value based on the voltage signal LVD1 having a voltage vm. When an L level signal in which the logic level of the H level modulation signal MS is inverted by the inverter 521 is input to the gate driver 532, the gate driver 532 outputs the gate signal LGD1 having a voltage value based on the ground potential voltage signal LVS1.

As described above, the amplification circuit 550 includes the gate drive circuit 530 that outputs the gate signal HGD1 and the gate signal LGD1 based on the modulation signal MS, the transistor M1 in which the voltage signal VHV1 is supplied to the drain terminal, which is one end, the source terminal, which is the other end, is electrically coupled to the midpoint CP1, and operates based on the gate signal HGD1 input to the gate terminal, and the transistor M2 in which the drain terminal, which is one end, is electrically coupled to the midpoint CP1, the ground potential is supplied to the source terminal, which is the other end, and which operates based on the gate signal LGD1 input to the gate terminal.

The level shift circuit 70 includes a reference level switching circuit 710, a gate drive circuit 730, diodes D11 and D12, capacitors C11 and C12, transistors M3 and M4, and a bootstrap circuit BS. The level shift circuit 70 outputs a level shift amplified modulation signal AMS2 obtained by level-shifting the reference potential of the amplified modulation signal AMS1 to a midpoint CP2.

Specifically, the base drive signal dA is input to the reference level switching circuit 710 included in the level shift circuit 70. The reference level switching circuit 710 generates a reference level switching signal LS based on the base drive signal dA and outputs the reference level switching signal LS to the gate drive circuit 730. Specifically, the reference level switching circuit 710 generates an H level reference level switching signal LS when the voltage value defined by the base drive signal dA is equal to or higher than a predetermined threshold voltage, and outputs the reference level switching signal LS to the gate drive circuit 730. The reference level switching circuit 710 generates an L level reference level switching signal LS when the voltage value defined by the base drive signal dA is less than the threshold voltage and outputs the reference level switching signal LS to the gate drive circuit 730. Here, the predetermined threshold voltage is equal to or lower than the voltage value of the voltage signal VHV1 supplied to the amplification circuit 550, and is preferably a voltage value closer to the voltage value of the voltage signal VHV1.

The gate drive circuit 730 outputs the gate signal HGD2 for driving the transistor M3 and the gate signal LGD2 for driving the transistor M4 according to the logic level of the reference level switching signal LS.

Specifically, the reference level switching signal LS output by the reference level switching circuit 710 is input to the gate driver 731 included in the gate drive circuit 730. The gate driver 731 generates and outputs a gate signal HGD2 obtained by level-shifting the input reference level switching signal LS. In addition, the reference level switching signal LS output by the reference level switching circuit 710 is input to the gate driver 732 of the gate drive circuit 730 after the logic level is inverted in the inverter 721. The gate driver 732 generates and outputs a gate signal LGD2 obtained by level-shifting a signal in which the logic level of the input reference level switching signal LS is inverted.

The transistors M3 and M4 are both configured to include N-channel MOS-FETs. The gate signal HGD2 output by the gate driver 731 is input to the gate terminal of the transistor M3. The voltage signal VHV3 output by the bootstrap circuit BS is supplied to the drain terminal of the transistor M3. The source terminal of the transistor M3 is electrically coupled to the midpoint CP2. In addition, the gate signal LGD2 output by the gate driver 732 is input to the gate terminal of the transistor M4. The drain terminal of the transistor M4 is electrically coupled to the midpoint CP2. The source terminal of the transistor M4 is electrically coupled to the midpoint CP1. The transistor M3 operates based on the gate signal HGD2, and the transistor M4 operates based on the gate signal LGD2, so that a level shift amplified modulation signal AMS2 obtained by level-shifting the reference potential of the amplified modulation signal AMS1 is generated at the midpoint CP2 where the transistor M3 and the transistor M4 are coupled.

That is, the transistor M3 included in the level shift circuit 70 is supplied with the voltage signal VHV3 output by the bootstrap circuit BS to the drain terminal, which is one end, has the source terminal, which is the other end, electrically coupled to the midpoint CP2, and operates based on the gate signal HGD2 output by the gate driver 731. The transistor M4 included in the level shift circuit 70 has a drain terminal, which is one end, electrically coupled to the midpoint CP2 and a source terminal, which is the other end, to which the amplified modulation signal AMS1 output from the amplification circuit 550 is supplied, and operates based on the gate signal LGD2 output by the gate driver 732. The level shift circuit 70 outputs the generated signal to the midpoint CP2 to which the transistor M3 and the transistor M4 are coupled as the level shift amplified modulation signal AMS2.

The bootstrap circuit BS includes a diode D13 and a capacitor C13. A voltage signal VHV2 is supplied to the anode terminal of the diode D13, and the cathode terminal of the diode D13 is electrically coupled to one end of the capacitor C13. In addition, the other end of the capacitor C13 is electrically coupled to the midpoint CP1. That is, the voltage signal VHV2 and the amplified modulation signal AMS1 output to the midpoint CP1 are input to the bootstrap circuit BS. The bootstrap circuit BS outputs a voltage signal VHV3 obtained by adding the voltage value of the amplified modulation signal AMS1 to the voltage value of the voltage signal VHV2 to the drain terminal of the transistor M3. In other words, the bootstrap circuit BS outputs the voltage signal VHV3 corresponding to the voltage signal VHV2 and the amplified modulation signal AMS1, which is obtained by level-shifting the reference potential of the amplified modulation signal AMS1 based on the voltage signal VHV2.

Here, the operation of the gate drive circuit 730 that outputs the gate signal HGD2 and the gate signal LGD2 based on the reference level switching signal LS will be described. The gate drive circuit 730 includes gate drivers 731 and 732. As described above, the reference level switching signal LS is input to the gate driver 731, and a signal in which the logic level of the reference level switching signal LS is inverted by the inverter 721 is input to the gate driver 732. That is, the signal input to the gate driver 731 and the signal input to the gate driver 732 are exclusively at the H level. Here, being H level exclusively includes the fact that the H level signals are not simultaneously input to the gate driver 731 and the gate driver 732. That is, the case where the L level signals are simultaneously input to the gate driver 731 and the gate driver 732 is not excluded.

The power supply terminal of the gate driver 731 on the low potential side is coupled to the midpoint CP2. Therefore, the signal generated at the midpoint CP2 is supplied to the power supply terminal of the gate driver 731 on the low potential side as the voltage signal HVS2. In addition, the power supply terminal of the gate driver 731 on the high potential side is electrically coupled to the cathode terminal of the diode D11 and one end of the capacitor C11. In addition, a voltage vm is supplied to the anode terminal of the diode D11, and the other end of the capacitor C11 is electrically coupled to the midpoint CP2. That is, the diode D11 and the capacitor C11 form a bootstrap circuit. The output voltage of the bootstrap circuit formed by the diode D11 and the capacitor C11 is supplied to the power supply terminal on the high potential side of the gate driver 731. That is, the voltage signal HVD2 having a voltage value higher than the voltage signal HVS2 by a voltage vm input to the power supply terminal of the gate driver 731 on the low potential side is supplied to the power supply terminal of the gate driver 731 on the high potential side. Therefore, when the H level reference level switching signal LS is input to the gate driver 731, the gate driver 731 outputs the gate signal HGD2 having a voltage value based on the voltage signal HVD2 which is higher than the voltage value of the midpoint CP2 by a voltage vm. When the L level reference level switching signal LS is input to the gate driver 731, the gate driver 731 outputs the gate signal HGD2 having a voltage value based on the voltage signal HVS2 which is the voltage value of the midpoint CP2.

The power supply terminal of the gate driver 732 on the low potential side is coupled to the midpoint CP1. Therefore, the amplified modulation signal AMS1 which is the signal generated at the midpoint CP1 is supplied as the voltage signal LVS2 to the power supply terminal of the gate driver 732 on the low potential side. In addition, the power supply terminal of the gate driver 732 on the high potential side is electrically coupled to the cathode terminal of the diode D12 and one end of the capacitor C12. In addition, a voltage vm is supplied to the anode terminal of the diode D12, and the other end of the capacitor C12 is electrically coupled to the midpoint CP1. That is, the bootstrap circuit including the diode D12 and the capacitor C13 is electrically coupled to the power supply terminal on the high potential side of the gate driver 732. Therefore, the voltage signal LVD2 having a voltage value higher than the voltage signal LVS2 by a voltage vm input to the power supply terminal of the gate driver 732 on the low potential side is supplied to the power supply terminal of the gate driver 732 on the high potential side.

Therefore, when an H level signal in which the logic level of the L level reference level switching signal LS is inverted by the inverter 721 is input to the gate driver 732, the gate driver 732 outputs a gate signal LGD2 having a voltage value based on the voltage signal LVD2 which is higher than the voltage value at the midpoint CP1 by a voltage vm. When an L level signal in which the logic level of the H level reference level switching signal LS is inverted by the inverter 721 is input to the gate driver 732, the gate driver 732 outputs a gate signal HGD2 having a voltage value based on the voltage signal LVS2 having a voltage value at the midpoint CP1.

Here, the gate drive circuit 730 outputs the gate signal HGD2 and the gate signal LGD2 based on the logic level of the reference level switching signal LS output by the reference level switching circuit 710. In addition, as described above, the logic level of the reference level switching signal LS output by the reference level switching circuit 710 is switched depending on whether or not the voltage value defined by the base drive signal dA is equal to or higher than a predetermined threshold voltage. That is, the gate drive circuit 730 outputs the gate signal HGD2 and the gate signal LGD2 based on the base drive signal dA.

In the level shift circuit 70 configured as described above, when the drain terminal and the source terminal of the transistor M3 are controlled to be non-conductive based on the gate signal HGD2, and the drain terminal and the source terminal of the transistor M4 are controlled to be conductive based on the gate signal LGD2, that is, when the reference level switching circuit 710 outputs the L level reference level switching signal LS, the midpoint CP1 of the amplification circuit 550 and the midpoint CP2 of the level shift circuit 70 are electrically coupled to each other via the transistor M4. Therefore, the level shift circuit 70 outputs the amplified modulation signal AMS1 supplied to the midpoint CP2 via the transistor M4 as the level shift amplified modulation signal AMS2.

On the other hand, when the drain terminal and the source terminal of the transistor M3 are controlled to be conductive based on the gate signal HGD2, and the drain terminal and the source terminal of the transistor M4 are controlled to be non-conductive based on the gate signal LGD2, that is, when the reference level switching circuit 710 outputs the H level reference level switching signal LS, the midpoint CP1 of the amplification circuit 550 and the midpoint CP2 of the level shift circuit 70 are electrically coupled via the bootstrap circuit BS and the transistor M3. Therefore, the level shift circuit 70 outputs the voltage signal VHV3 obtained by level-shifting the reference potential of the amplified modulation signal AMS1 based on the voltage signal VHV2 as the level shift amplified modulation signal AMS2.

Here, in the following description, an operation mode in which the level shift circuit 70 outputs the level shift amplified modulation signal AMS2 having the reference potential of the amplified modulation signal AMS1 as the ground potential is referred to as a first mode MD1, and an operation mode in which the level shift circuit 70 outputs the level shift amplified modulation signal AMS2 obtained by level-shifting the reference potential of the amplified modulation signal AMS1 to a voltage signal VHV2 different from the ground potential and higher than the ground potential is referred to as a second mode MD2. That is, the level shift circuit 70 is in the first mode MD1 when the voltage value defined by the base drive signal dA is lower than the predetermined threshold voltage, and is in the second mode MD2 when the voltage value defined by the base drive signal dA is higher than the predetermined threshold voltage.

The level shift amplified modulation signal AMS2 output by the level shift circuit 70 is input to the demodulation circuit 560. The demodulation circuit 560 generates a drive signal COM by demodulating the level shift amplified modulation signal AMS2 output by the level shift circuit 70 by smoothing the level shift amplified modulation signal AMS2 and outputs the drive signal COM from the drive circuit 50. In other words, the demodulation circuit 560 outputs the drive signal COM by demodulating the level shift amplified modulation signal AMS2.

The demodulation circuit 560 includes an inductor L10 and a capacitor C10. One end of the inductor L10 is electrically coupled to the midpoint CP2. The other end of the inductor L10 is electrically coupled to one end of the capacitor C10. A ground potential is supplied to the other end of the capacitor C10. That is, the inductor L10 and the capacitor C10 form a low-pass filter circuit. As a result, the level shift amplified modulation signal AMS2 output from the level shift circuit 70 is smoothed and output from the drive circuit 50 as a drive signal COM.

The first feedback circuit 570 and the second feedback circuit 580 feed back the drive signal COM to the correction circuit 510.

The first feedback circuit 570 includes an attenuator 572. The drive signal COM is input to the attenuator 572. The attenuator 572 feeds back to the correction circuit 510 as the first feedback signal VFB1 obtained by attenuating the voltage value of the drive signal COM.

The second feedback circuit 580 includes capacitors C21, C22, and C23 and resistors R21 and R22. The drive signal COM is supplied to one end of the capacitor C21. The other end of the capacitor C21 is coupled to one end of the resistor R21 and one end of the resistor R22. The ground potential is supplied to the other end of the resistor R21. As a result, the capacitor C21 and the resistor R21 function as high-pass filters. In other words, the second feedback circuit 580 includes a high-pass filter. The high-pass filter removes a low-frequency component of the drive signal COM input to the second feedback circuit 580. As a result, a triangular wave-shaped signal caused by the ripple component superimposed on the drive signal COM is extracted. Here, the triangular wave-shaped signal means that a signal that does not strictly become a triangular wave is included according to the frequency characteristic of the second feedback circuit 580. In the following description, the signal extracted by the second feedback circuit 580 will be described as a triangular wave.

In addition, the other end of the resistor R22 is coupled to one end of the capacitor C22 and one end of the capacitor C23. The ground potential is supplied to the other end of the capacitor C22. As a result, in the second feedback circuit 580, the resistor R22 and the capacitor C22 function as a low-pass filter. That is, the second feedback circuit 580 includes a low-pass filter. The cut-off frequency of the low-pass filter is set to be sufficiently higher than the cut-off frequency of the high-pass filter including the capacitor C21 and the resistor R21. As a result, the low-pass filter configured to include the resistor R22 and the capacitor C22 removes the high-frequency noise component superimposed on the output of the high-pass filter configured to include the capacitor C21 and the resistor R21.

As described above, the second feedback circuit 580 functions as a band pass filter through which a signal in a predetermined frequency range included in the drive signal COM is passed. The second feedback circuit 580 attenuates the signal passing through the band pass filter by the attenuator 582, and then feeds back the signal as the second feedback signal VFB2 to the correction circuit 510. As a result, a triangular wave signal obtained by extracting the high frequency component included in the drive signal COM, specifically, a triangular wave signal corresponding to the cycle of the ripple voltage superimposed on the drive signal COM according to the amplified modulation signal AMS1, is fed back to the correction circuit 510 as a second feedback signal VFB2 by the second feedback circuit 580.

Here, the drive signal COM output by the drive circuit 50 is a signal obtained by smoothing the level shift amplified modulation signal AMS2 obtained by level-shifting the reference voltage of the amplified modulation signal AMS1 by a low-pass filter included in the demodulation circuit 560. The drive signal COM output by such a drive circuit 50 feeds back to the correction circuit 510 via the first feedback circuit 570, so that the drive circuit 50 performs self-excited oscillation at a frequency determined by the delay of the first feedback circuit 570 and the feedback transfer function. However, the amount of delay is large in the feedback path via the first feedback circuit 570, and thus the frequency of the self-excited oscillation of the drive circuit 50 may not be increased to such an extent that the accuracy of the drive signal COM can be sufficiently ensured. Therefore, in the drive circuit 50 of the present embodiment, a feedback path via the second feedback circuit 580 is provided in addition to the feedback path via the first feedback circuit 570. As a result, the high frequency components included in the drive signal COM can be individually fed back, and the amount of delay when viewed in the entire circuit can be reduced. As a result, the frequency of the correction base drive signal oA and the frequency of the modulation signal MS can be increased to such an extent that the accuracy of the drive signal COM can be sufficiently ensured.

As described above, when the operation mode is the first mode MD1, the drive circuit 50 outputs the reference potential of the amplified modulation signal AMS1 output by the amplification circuit 550 as a level shift amplified modulation signal AMS2 without level shifting. In such a first mode MD1, a voltage vcom, which is the voltage value of the drive signal COM output by the drive circuit 50 at a predetermined timing, can be expressed by the following equation (1) from the on-duty AMon of the amplified modulation signal AMS1 and the voltage vhv1, which is the voltage value of voltage signal VHV1.

vcom=AMon×vhv1 (1)

In view of the fact that the signal obtained by amplifying the modulation signal MS by the amplification circuit 550 is the amplified modulation signal AMS1, the on-duty AMon of the amplified modulation signal AMS1 and the on-duty Mon of the modulation signal MS are substantially equal to each other, and the on-duty AMon of the above equation (1) can be replaced with the on-duty Mon of the modulation signal MS. In this manner, the voltage vcom, which is a voltage value at a predetermined timing of the drive signal COM output by the drive circuit 50, can be expressed as the following equation (2).

vcom=Mon×vhv1 (2)

That is, the drive circuit 50 outputs the drive signal COM of the voltage value based on the on-duty Mon of the modulation signal MS obtained by modulating the correction base drive signal oA.

Next, the on-duty Mon of the modulation signal MS will be described. FIG. 11 is a graph for describing the relationship between the correction base drive signal oA and the modulation signal MS. As described above, the correction base drive signal oA output by the correction circuit 510 is a signal obtained by subtracting the first feedback signal VFB1 and the second feedback signal VFB2 from the base drive signal aA output by the DAC 511, and the second feedback signal VFB2 input to the correction circuit 510 is a triangular wave signal based on the cycle of the ripple voltage superimposed on the drive signal COM according to the frequency of the amplified modulation signal AMS1.

Therefore, when the voltage value of the base drive signal aA is the voltage vaa, the voltage value of the first feedback signal VFB1 is the voltage vfb1, the voltage value of the predetermined offset voltage is voltage vo, and the voltage amplitude of the second feedback signal VFB2 as the triangular wave is amplitude A, the correction base drive signal oA is a triangular wave whose voltage value changes within the range of the following equations (4) to (5) according to the cycle of the ripple voltage superimposed on the drive signal COM with the median value of voltage v1 expressed in the following equation (3).

v1=(vaa−vfb1)+vo (3)

v2=(vdaa−vfb1)+vo+A/2 (4)

v3=(vdaa−vfb1)+vo−A/2 (5)

Here, the voltage vo expressed in the above equations (3) to (5) is a voltage value of a predetermined offset voltage and corresponds to any voltage value for correcting errors and variations occurring in the drive circuit 50, such as a voltage value of a DC voltage component remaining in the triangular wave as the second feedback signal VFB2 and a voltage value of an offset voltage of the comparator constituting the modulation circuit 520.

The modulation circuit 520 compares the voltage value of the correction base drive signal oA output from the correction circuit 510 with the voltage vref as the reference voltage to generate and output the modulation signal MS that is H level when the voltage value of the correction base drive signal oA is higher than the voltage value of voltage vref, and that is L level when the voltage value of the correction base drive signal oA is lower than the voltage value of voltage vref.

At this time, the on-duty Mon of the modulation signal MS output by the modulation circuit 520 can be expressed by the following equation (6) from FIG. 11.

$$Mon = \frac{A - ( \frac{A}{2} + ( vref - v 1 ) )}{A} \qquad ( 6 )$$

By substituting the equation (3) into the above equation (6), the on-duty Mon of the modulation signal MS output by the modulation circuit 520 can be expressed as the following equation (7).

$$Mon = \frac{\frac{A}{2} + ( vaa - vfb 1 - vref + vo )}{A} \qquad ( 7 )$$

In addition, the voltage vfb1, which is a voltage value of the first feedback signal VFB1, is a voltage value obtained by attenuating the voltage vcom, which is a voltage value of the drive signal COM, in the first feedback circuit 570. Therefore, when the attenuation rate of the attenuator 572 included in the first feedback circuit 570 is a, the voltage vfb1, which is the voltage value of the first feedback signal VFB1, can be expressed by the following equation (8).

vfb1=α×vcom tm (8)

By substituting the equations (7) and (8) into the above-described equation (2) and rearranging the equations, a voltage vcom which is a voltage value at a predetermined timing of the drive signal COM output by the drive circuit 50 in the first mode MD1 can be expressed as the following equation (9).

$$vcom = \frac{vhv 1 ( \frac{A}{2} + vaa - ( vref - vo ) )}{A + ( α \times vhv )} \qquad ( 9 )$$

On the other hand, when the operation mode is in the second mode MD2, the drive circuit 50 outputs a signal obtained by level-shifting the reference potential of the amplified modulation signal AMS1 output by the amplification circuit 550 to the voltage signal VHV2 as a level shift amplified modulation signal AMS2. In such a second mode MD2, the voltage vcom which is a voltage value at a predetermined timing of the drive signal COM output by the drive circuit 50 is a value obtained by adding the voltage vhv2, which is a voltage value of the voltage signal VHV2 level-shifted to the above equation (2), and can be expressed as the following equation (10).

vcom=Mon×vhv1+vhv2 (10)

By substituting the equations (7) and (8) into the above-described equation (10) and rearranging the equations, a voltage vcom which is a voltage value at a predetermined timing of the drive signal COM output by the drive circuit 50 in the second mode MD2 can be expressed as the following equation (11).

$$vcom = \frac{vhv 1 ( \frac{A}{2} + vaa - ( vref - vo ) ) + A \times vhv 2}{A + ( α \times vhv 1 )} \qquad ( 11 )$$

In the liquid discharge apparatus 1 according to the present embodiment, the voltage vcom as the drive signal COM output by the drive circuit 50 in the first mode MD1 and the voltage vcom as the drive signal COM output by the drive circuit 50 in the second mode MD2 continuously change based on the base drive signal dA input to the drive circuit 50. As a result, the drive circuit 50 outputs a drive signal COM having a signal waveform as illustrated in FIG. 5. However, the output voltage value differs between the voltage vcom which is a voltage value at a predetermined timing of the drive signal COM output by the drive circuit 50 in the first mode MD1 expressed in the equation (9) and the voltage vcom which is a voltage value at a predetermined timing of the drive signal COM output by the drive circuit 50 in the second mode MD2 expressed in the equation (11).

Specifically, in the first mode MD1, when the voltage vcom, which is the voltage value at a predetermined timing of the drive signal COM output by the drive circuit 50, is defined as the voltage vcom1, and in the second mode MD2, when the voltage vcom, which is the voltage value at a predetermined timing of the drive signal COM output by the drive circuit 50, is defined as the voltage vcom2, a potential difference is generated between the voltage vcom1 and the voltage vcom2 as expressed in the following equation (12).

$$vcom 2 - vcom 1 = \frac{A \times vhv 2}{A + ( α \times vhv 1 )} \qquad ( 12 )$$

That is, when the operation mode of the drive circuit 50 transitions from the first mode MD1 to the second mode MD2 or from the second mode MD2 to the first mode MD1, the voltage vcom, which is the voltage value of the drive signal COM output by the drive circuit 50, is discontinuous, and as a result, there is a possibility that the signal waveform of the drive signal COM output by the drive circuit 50 is distorted. Such distortion of the signal waveform generated in the drive signal COM causes variations in the drive characteristics of the piezoelectric element 60, and as a result, there is a possibility that the discharge characteristics of the ink in the liquid discharge apparatus 1 are deteriorated.

To solve the problem, in the liquid discharge apparatus 1 of the present embodiment, the correction circuit 510 of the drive circuit 50 includes the base drive signal correction circuit 513. The base drive signal correction circuit 513 subtracts a predetermined correction value from the base drive signal dA according to the logic level of the reference level switching signal LS output by the reference level switching circuit 710. Therefore, when the operation mode of the drive circuit 50 transitions from the first mode MD1 to the second mode MD2 and when the operation mode of the drive circuit 50 transitions from the second mode MD2 to the first mode MD1, the possibility that the signal waveform of the drive signal COM output by the drive circuit 50 is distorted is reduced. As a result, the possibility that the discharge characteristics of the ink in the liquid discharge apparatus 1 are deteriorated is reduced.

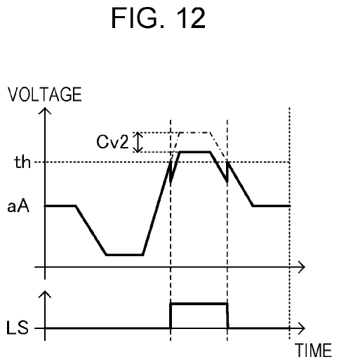

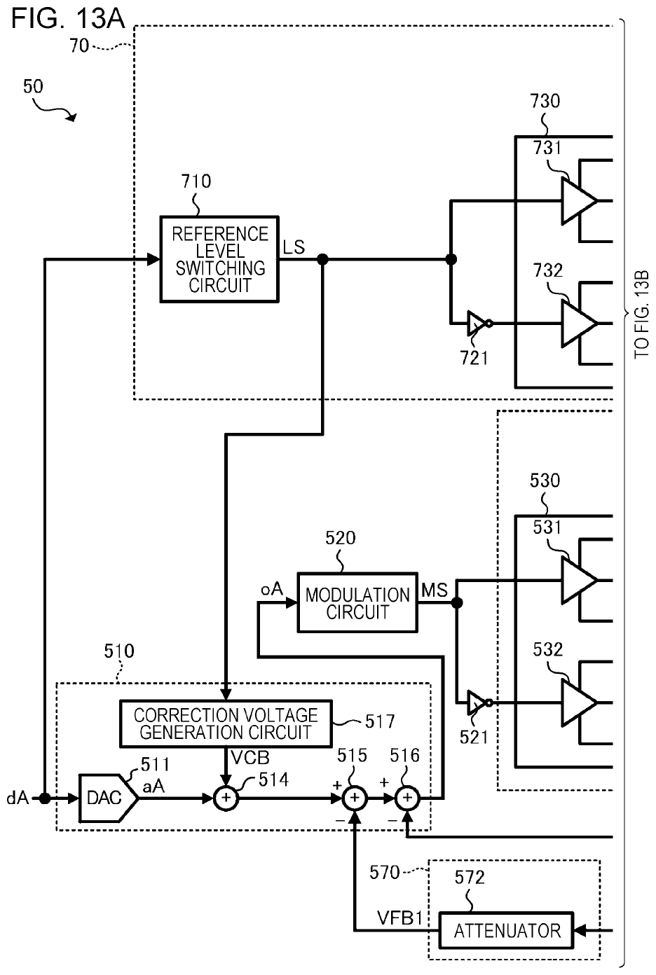

The operation of the correction circuit 510 will be described with reference to FIG. 12. FIG. 12 is a graph for describing the relationship between the base drive signal aA and the reference level switching signal LS. As described above, when the voltage value defined by the base drive signal dA, which is a digital signal, is equal to or less than the predetermined threshold value th, the reference level switching circuit 710 outputs the L level reference level switching signal LS. Therefore, the L level reference level switching signal LS is input to the base drive signal correction circuit 513. When the L level reference level switching signal LS is input to the base drive signal correction circuit 513, the base drive signal correction circuit 513 outputs a correction signal dAJ obtained by adding “0” as a predetermined correction value Cv1 to the base drive signal dA. Therefore, the DAC 511 generates and outputs the base drive signal aA obtained by digital-analog converting the base drive signal dA.

On the other hand, when the voltage value defined by the base drive signal dA, which is a digital signal, exceeds a predetermined threshold value th, the reference level switching circuit 710 outputs the H level reference level switching signal LS. Therefore, the H level reference level switching signal LS is input to the base drive signal correction circuit 513. When the H level reference level switching signal LS is input to the base drive signal correction circuit 513, the base drive signal correction circuit 513 outputs a correction signal dAJ obtained by subtracting the correction value calculated based on the above equation (12) from the base drive signal dA as a predetermined correction value Cv2. Therefore, the DAC 511 generates and outputs a base drive signal aA having a voltage value lower than the base drive signal dA only by a correction value Cv2.

Therefore, in the first mode MD1 in which the level shift circuit 70 outputs the level shift amplified modulation signal AMS2 in which the reference potential of the amplified modulation signal AMS1 is the ground potential, the correction circuit 510 outputs a correction base drive signal oA corrected by the correction value Cv1. In the second mode MD2 in which the level shift circuit 70 outputs the level shift amplified modulation signal AMS2 obtained by level-shifting the reference potential of the amplified modulation signal AMS1 to the voltage signal VHV2 different from the ground potential, the correction circuit 510 outputs a correction base drive signal oA corrected by a correction value Cv2 different from the correction value Cv1, specifically, a correction value calculated based on the equation (12).

As a result, when the operation mode of the drive circuit 50 is switched from the first mode MD1 to the second mode MD2, and the operation mode of the drive circuit 50 is switched from the second mode MD2 to the first mode MD1, the voltage vcom, which is the voltage value of the drive signal COM, changes continuously, and as a result, the possibility that the signal waveform of the drive signal COM is distorted is reduced. Therefore, the possibility that the discharge characteristics of the ink in the liquid discharge apparatus 1 are deteriorated is reduced.

Here, in the base drive signal correction circuit 513, when the L level reference level switching signal LS is input from the reference level switching circuit 710, a correction signal dAJ obtained by adding a correction value based on the above equation (12) to the base drive signal dA as a predetermined correction value Cv1 may be output, and when the H level reference level switching signal LS is input, a correction signal dAJ obtained by adding “0” to the base drive signal dA as a predetermined correction value Cv2 may be output.

In addition, the values used for the correction values Cv1 and Cv2 are not limited to the values calculated by the above equation (12), and for example, may be a value obtained by adding errors and variations occurring in the drive circuit 50 and loss that may occur due to the operation of the drive circuit 50 to the value calculated by the above equation (12). In addition, the correction values Cv1 and Cv2 may be calculated each time by the base drive signal correction circuit 513 or an arithmetic circuit (not illustrated), or may be stored in a storage circuit (not illustrated).

Here, the piezoelectric element 60 is an example of a capacitive load, and the drive circuit 50 corresponds to a capacitive load drive circuit. In view of the fact the drive signal COM output by the drive circuit 50 is an example of a drive signal and the drive signal VOUT is generated based on the drive signal COM, the drive signal VOUT is also an example of a drive signal. The midpoint CP1 is an example of a first output point, and the midpoint CP2 is an example of a second output point. In addition, the second feedback circuit 580 is an example of a feedback circuit. In addition, the ground potential is an example of a first potential, and a potential based on the voltage vhv2 different from the ground potential is an example of a second potential. In addition, the correction value Cv1 is an example of a first correction value, and the correction value Cv2 is an example of a second correction value. In addition, the gate signal HGD1 is an example of a first gate signal, the gate signal LGD1 is an example of a second gate signal, and the gate drive circuit 530 that outputs the gate signal HGD1 and the gate signal LGD1 is an example of a first gate drive circuit. In addition, the gate signal HGD2 is an example of a third gate signal, the gate signal LGD2 is an example of a fourth gate signal, and the gate drive circuit 730 that outputs the gate signal HGD2 and the gate signal LGD2 is an example of a second gate drive circuit. In addition, the transistor M1 is an example of a first transistor, the transistor M2 is an example of a second transistor, the transistor M3 is an example of a third transistor, and the transistor M4 is an example of a fourth transistor. In addition, the voltage signal VHV1 is an example of a first voltage signal, the ground potential is an example of a second voltage signal, the voltage signal VHV2 is an example of a third voltage signal, and the voltage signal VHV3 is an example of a fourth voltage signal. A voltage value less than a predetermined threshold voltage among the voltage values defined by the base drive signal dA is an example of a first voltage value, and A voltage value equal to or higher than a predetermined threshold voltage among the voltage values defined by the base drive signal dA is an example of a second voltage value.

### 1.5. Action and Effect

As described above, in the drive circuit 50 included in the liquid discharge apparatus 1 of the present embodiment, in the first mode MD1 in which the level shift circuit 70 outputs the level shift amplified modulation signal AMS2 in which the reference potential of the amplified modulation signal AMS1 is the ground potential, the correction circuit 510 outputs a correction base drive signal oA corrected by the correction value Cv1. In the second mode MD2 in which the level shift circuit 70 outputs the level shift amplified modulation signal AMS2 obtained by level-shifting the reference potential of the amplified modulation signal AMS1 to a potential based on the voltage vhv2 different from the ground potential, the correction circuit 510 outputs a correction base drive signal oA corrected by a correction value Cv2 different from the correction value Cv1. The modulation circuit 520 outputs the modulation signal MS obtained by modulating the correction base drive signal oA, the amplification circuit 550 outputs the amplified modulation signal AMS1 obtained by amplifying the modulation signal MS, the level shift circuit 70 outputs a level shift amplified modulation signal AMS2 obtained by level-shifting the reference potential of the amplified modulation signal AMS1, and the demodulation circuit 560 demodulates the level shift amplified modulation signal AMS2 to output the drive signal COM. That is, the drive circuit 50 included in the liquid discharge apparatus 1 of the present embodiment generates and outputs the drive signal COM based on the correction base drive signal oA obtained by correcting the base drive signal dA using different correction values Cv1 and Cv2 according to the operation mode output by the correction circuit 510. As a result, even when transitioning from the first mode MD1 to the second mode MD2 and the transitioning from the second mode MD2 to the first mode MD1, the possibility that the signal waveform of the drive signal COM is distorted is reduced. That is, the waveform accuracy of the drive signal COM output by the drive circuit 50 is improved, and as a result, the ink discharge accuracy of the liquid discharge apparatus 1 provided with the drive circuit 50 is further improved.

### 2. Second Embodiment

Next, a liquid discharge apparatus 1 and a drive circuit 50 of a second embodiment will be described. Although in the liquid discharge apparatus 1 and the drive circuit 50 of the first embodiment, it is described that the correction circuit 510 generates the correction base drive signal oA by correcting the digital base drive signal dA input to the drive circuit 50, the liquid discharge apparatus 1 and the drive circuit 50 of the second embodiment are different from the liquid discharge apparatus 1 and the drive circuit 50 of the first embodiment in that the correction circuit 510 converts the base drive signal dA, which is a digital signal, into the base drive signal aA, which is an analog signal, and then generates a correction base drive signal oA by subtracting a predetermined correction value from the base drive signal aA. In describing the liquid discharge apparatus 1 and the drive circuit 50 of the second embodiment, the same configurations as those of the liquid discharge apparatus 1 and the drive circuit 50 of the first embodiment are denoted by the same reference numerals, and the description thereof will be simplified or omitted.

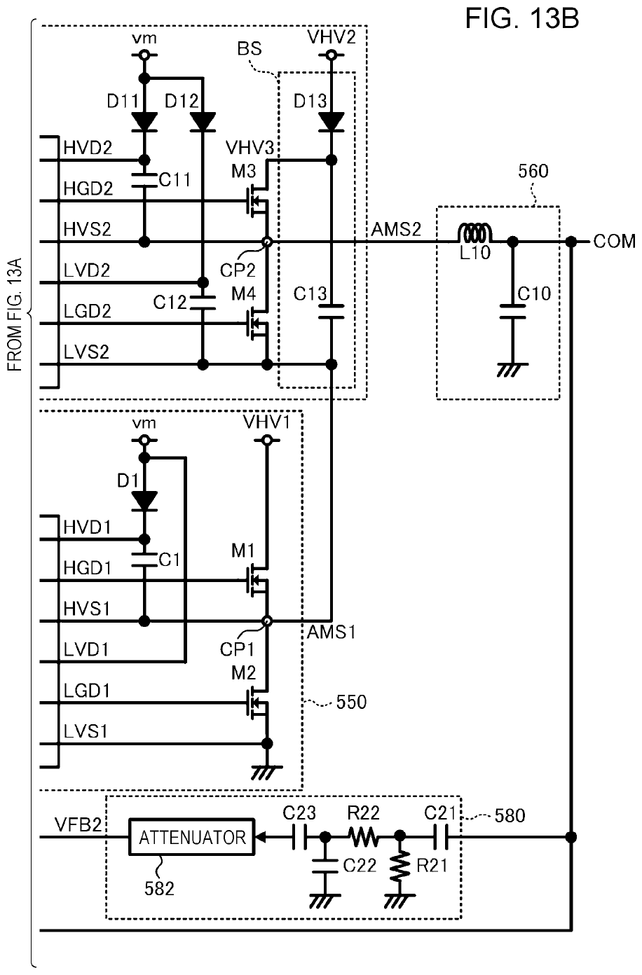

FIGS. 13A and 13B are diagrams illustrating an example of the functional configuration of the drive circuit 50 according to the second embodiment. As illustrated in FIGS. 13A and 13B, in the drive circuit 50 of the modification example, the correction circuit 510 includes a DAC 511, adders 514, 515, and 516, and a correction voltage generation circuit 517.

The DAC circuit 511 generates and outputs a base drive signal aA which is an analog signal by digital-analog converting the base drive signal dA which is a digital signal.

The reference level switching signal LS is input from the level shift circuit 70 to the correction voltage generation circuit 517. The correction voltage generation circuit 517 generates a correction voltage VCB corresponding to the logic level of the input reference level switching signal LS. Specifically, the correction voltage generation circuit 517 generates the correction voltage VCB having different voltage values when the L level reference level switching signal LS is input and when the H level reference level switching signal LS is input.

The base drive signal aA is input to one of the input terminals on the + side of the adder 514, and the correction voltage VCB is input to the other of the input terminals on the + side of the adder 514. The adder 514 subtracts the correction voltage VCB from the base drive signal aA to output a signal obtained by correcting the base drive signal aA based on the correction voltage VCB.

A signal output by the adder 514 is input to the input terminal on the + side of the adder 515, and a first feedback signal VFB1 is input to the input terminal on the − side of the adder 515. The adder 515 outputs a signal obtained by subtracting the first feedback signal VFB1 from the base drive signal aA. A signal output by the adder 515 is input to the input terminal on the + side of the adder 516, and a second feedback signal VFB2 is input to the input terminal on the—side of the adder 516. The adder 516 outputs a signal obtained by subtracting the second feedback signal VFB2 from the signal output by the adder 515 from the correction circuit 510 as the correction base drive signal oA.

The drive circuit 50 generates and outputs a drive signal COM based on the correction base drive signal oA output by the correction circuit 510, as in the first embodiment.

The liquid discharge apparatus 1 and the drive circuit 50 provided with the drive circuit 50 having the correction circuit 510 configured as described above also have the same effects as the liquid discharge apparatus 1 and the drive circuit 50 according to the first embodiment.

Here, the base drive signal aA based on the base drive signal dA is an example of the base drive signal of the second embodiment, the voltage value of the correction voltage VCB output by the correction voltage generation circuit 517 when the L level reference level switching signal LS is input is an example of the first correction value of the second embodiment, and the voltage value of the correction voltage VCB output by the correction voltage generation circuit 517 when the H level reference level switching signal LS is input is an example of the second correction value of the second embodiment.

### 3. Third Embodiment

Next, a liquid discharge apparatus 1 and a drive circuit 50 of a third embodiment will be described. The liquid discharge apparatus 1 and the drive circuit 50 of the third embodiment are different from the liquid discharge apparatuses 1 and drive circuits 50 of the first embodiment and the second embodiment in that the level shift circuit 70 includes a timing control circuit 711. In describing the liquid discharge apparatus 1 and the drive circuit 50 of the third embodiment, the same configurations as those of the liquid discharge apparatus 1 and the drive circuit 50 of the first embodiment and the second embodiment are denoted by the same reference numerals, and the description thereof will be simplified or omitted.

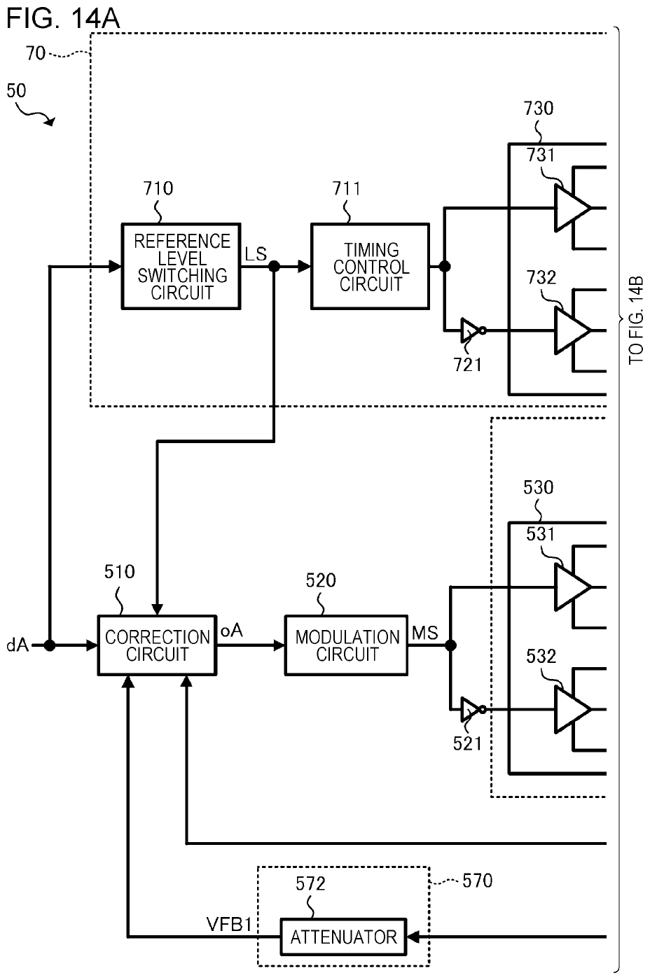

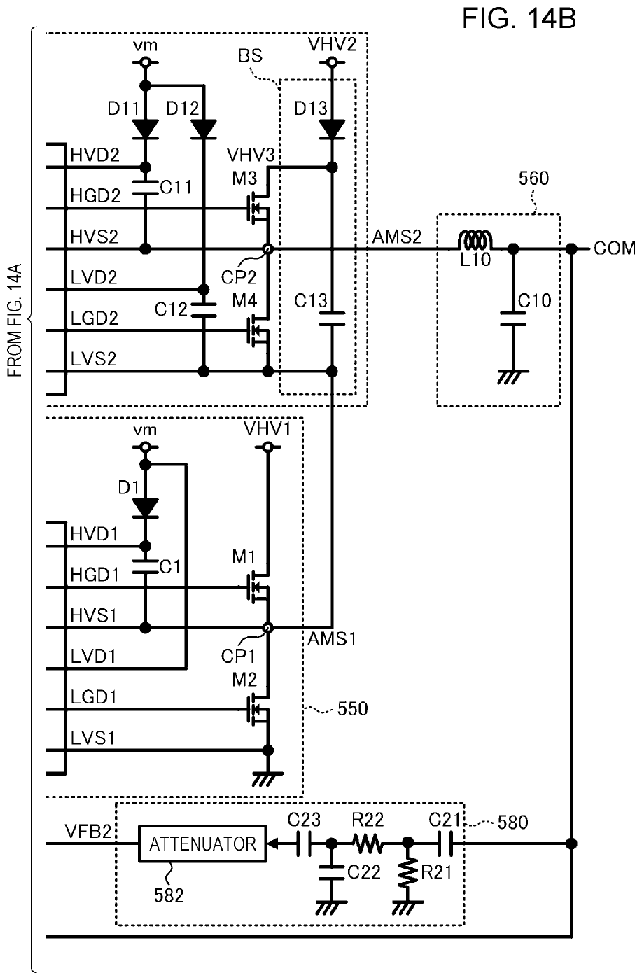

FIGS. 14A and 14B are diagrams illustrating an example of the functional configuration of the drive circuit 50 according to the third embodiment. As illustrated in FIGS. 14A and 14B, in the drive circuit 50 of the third embodiment, the level shift circuit 70 includes a timing control circuit 711. The reference level switching signal LS output by the reference level switching circuit 710 is input to the timing control circuit 711. The timing control circuit 711 delays the input reference level switching signal LS for a certain period of time, and then outputs the signal to the gate drive circuit 730.

The time until the transistors M3 and M4 of the level shift circuit 70 are controlled by the logic level of the reference level switching signal LS output by the reference level switching circuit 710 and the time until the amplification circuit 550 is controlled by the correction base drive signal oA obtained by reflecting the correction after the base drive signal dA or the base drive signal aA is corrected by the logic level of the reference level switching signal LS output by the reference level switching circuit 710 may be different from each other.

The timing control circuit 711 corrects the time difference that may occur between the time until the transistors M3 and M4 of the level shift circuit 70 are controlled by the logic level of the reference level switching signal LS output by the reference level switching circuit 710 and the time until the amplification circuit 550 is controlled by the correction base drive signal oA obtained by reflecting the correction after the base drive signal dA or the base drive signal aA is corrected by the logic level of the reference level switching signal LS output by the reference level switching circuit 710. Therefore, the waveform accuracy of the drive signal COM output by the drive circuit 50 is further improved.

### 4. Fourth Embodiment

Next, a liquid discharge apparatus 1 and a drive circuit 50 of a fourth embodiment will be described. The liquid discharge apparatus 1 according to the fourth embodiment and the drive circuit 50 are different from the liquid discharge apparatuses 1 and drive circuits 50 of the first embodiment, the second embodiment, and the third embodiment in that a level shift circuit 70 configured in a plurality of stages is provided. In describing the liquid discharge apparatus 1 and the drive circuit 50 of the fourth embodiment, the same configurations as those of the liquid discharge apparatus 1 and the drive circuit 50 of the first embodiment, the second embodiment, and the third embodiment are denoted by the same reference numerals, and the description thereof will be simplified or omitted.

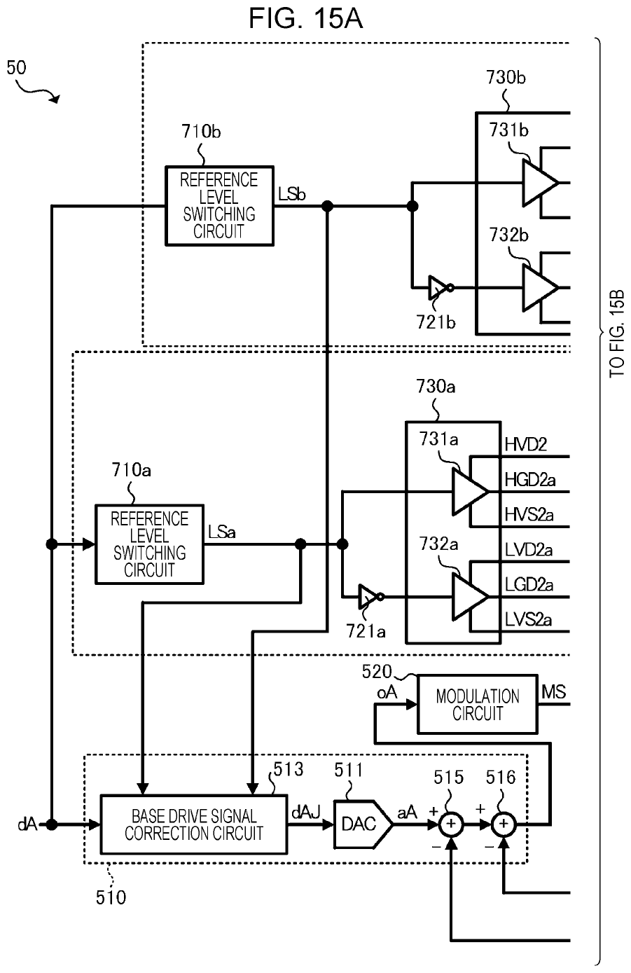

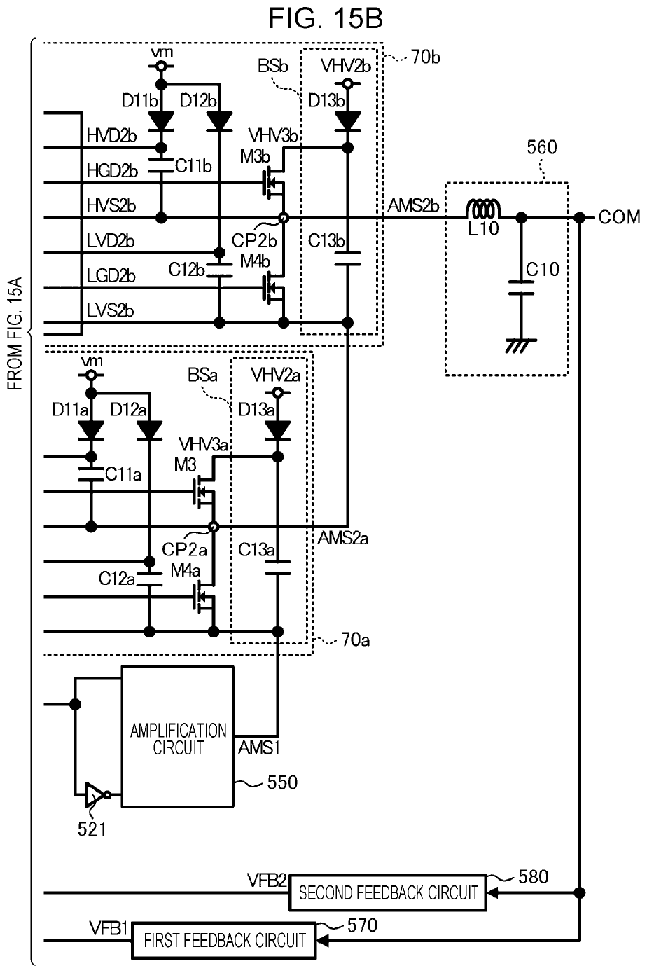

FIGS. 15A and 15B are diagrams illustrating an example of the functional configuration of the drive circuit 50 according to the fourth embodiment. As illustrated in FIGS. 15A and 15B, the drive circuit 50 of the fourth embodiment includes a level shift circuit 70a and a level shift circuit 70b. Here, each of the level shift circuit 70a and the level shift circuit 70b has the same configuration as the level shift circuit 70 of the first embodiment, and perform the same operation. In FIGS. 15A and 15B, in order to distinguish between various configurations of the level shift circuit 70a and various configurations of the level shift circuit 70b, “a” is added to the end of the reference numerals for the configuration of the level shift circuit 70a, and “b” is added to the end of the reference numerals for the configuration of the level shift circuit 70b corresponding to various configurations of the level shift circuit 70 of the first embodiment. Specifically, the configuration of the level shift circuit 70a corresponding to the reference level switching circuit 710 of the level shift circuit 70 of the first embodiment is referred to as a reference level switching circuit 710a, and the configuration of the level shift circuit 70b is referred to as a reference level switching circuit 710b.

Similarly, in order to distinguish between the various signals generated by the level shift circuit 70a and the various signals generated by the level shift circuit 70b, “a” is added to the end of the reference numerals of the signal of the level shift circuit 70a corresponding to various signals generated by the level shift circuit 70 of the first embodiment, and an “b” is added to the end of the reference numerals of the signal of the level shift circuit 70b corresponding to various signals generated by the level shift circuit 70 of the first embodiment. Specifically, the signal of the level shift circuit 70a corresponding to the reference level switching signal LS included in the level shift circuit 70 of the first embodiment is referred to as a reference level switching signal LSa, and the signal of the level shift circuit 70b is a referred to as a reference level switching signal LSb.

The base drive signal dA and the amplified modulation signal AMS1 output by the amplification circuit 550 are input to the level shift circuit 70a. When the voltage value defined by the base drive signal dA is equal to or higher than a predetermined threshold voltage, the level shift circuit 70a outputs the level shift amplified modulation signal AMS2a obtained by level-shifting the reference potential of the input amplified modulation signal AMS1 to a voltage vhv2a which is the voltage value of the voltage signal VHV2a, and when the voltage value defined by the base drive signal dA is less than a predetermined threshold voltage, the level shift circuit 70a outputs the input amplified modulation signal AMS1 as the level shift amplified modulation signal AMS2a.

The base drive signal dA and the level shift amplified modulation signal AMS2a output by the level shift circuit 70a are input to the level shift circuit 70b. When the voltage value defined by the base drive signal dA is equal to or higher than a predetermined threshold voltage, the level shift circuit 70b outputs the level shift amplified modulation signal AMS2b obtained by level-shifting the reference potential of the input level shift amplified modulation signal AMS2a to a voltage vhv2b which is the voltage value of the voltage signal VHV2b, and when the voltage value defined by the base drive signal dA is less than a predetermined threshold voltage, the level shift circuit 70b outputs the input level shift amplified modulation signal AMS2a as the level shift amplified modulation signal AMS2b.

The level shift amplified modulation signal AMS2b output by the level shift circuit 70b is input to the demodulation circuit 560. The demodulation circuit 560 generates a drive signal COM by demodulating the input level shift amplified modulation signal AMS2b. The drive signal COM is output from the drive circuit 50.

In addition, when the voltage value defined by the input base drive signal dA is equal to or higher than a predetermined threshold voltage, the reference level switching circuit 710a included in the level shift circuit 70a generates an H level reference level switching signal LSa, outputs the signal to the gate drive circuit 730a and the correction circuit 510, and when the voltage value defined by the base drive signal dA is less than the threshold voltage, the reference level switching circuit 710a generates an L level reference level switching signal LSa, outputs the signal to the gate drive circuit 730a and the correction circuit 510.

Similarly, when the voltage value defined by the input base drive signal dA is equal to or higher than a predetermined threshold voltage, the reference level switching circuit 710b included in the level shift circuit 70b generates an H level reference level switching signal LSb, outputs the signal to the gate drive circuit 730b and the correction circuit 510, and when the voltage value defined by the base drive signal dA is less than the threshold voltage, the reference level switching circuit 710b generates an L level reference level switching signal LSb, outputs the signal to the gate drive circuit 730b and the correction circuit 510.

Here, a threshold voltage at which the logic level of the reference level switching signal LSa output by the reference level switching circuit 710a included in the level shift circuit 70a is switched and a threshold voltage at which the logic level of the reference level switching signal LSb output by the reference level switching circuit 710b included in the level shift circuit 70b is switched are different from each other. Specifically, the threshold voltage at which the logic level of the reference level switching signal LSa output by the reference level switching circuit 710a included in the level shift circuit 70a is switched is lower than the threshold voltage at which the logic level of the reference level switching signal LSb output by the reference level switching circuit 710b included in the level shift circuit 70b is switched.

The correction circuit 510 outputs the correction base drive signal oA obtained by correcting the base drive signal dA or the base drive signal aA using a correction value based on the logic level of the reference level switching signal LSa output by the reference level switching circuit 710a and the logic level of the reference level switching signal LSb output by the reference level switching circuit 710b. The drive circuit 50 generates and outputs a drive signal COM based on the correction base drive signal oA output by the correction circuit 510.

The liquid discharge apparatus 1 and the drive circuit 50 provided with the drive circuit 50 having the correction circuit 510 configured as described above also have the same effects as the liquid discharge apparatus 1 and the drive circuit 50 according to the first embodiment.

Although the embodiments and the modification example have been described above, the present disclosure is not limited to these embodiments, and can be implemented in various aspects without departing from the gist thereof. For example, the above embodiments can be combined as appropriate.

The present disclosure includes a configuration substantially the same as the configuration described in the embodiments (for example, a configuration having the same function, method, and result, or a configuration having the same object and effect). In addition, the present disclosure also includes a configuration in which a non-essential part of the configuration described in the embodiments is replaced. In addition, the present disclosure also includes a configuration that exhibits the same action and effect as those of the configuration described in the embodiments or a configuration that can achieve the same object. In addition, the present disclosure also includes a configuration in which a known technique is added to the configuration described in the embodiments.

The following contents are derived from the above-described embodiments.

According to another aspect of the present disclosure, there is provided a liquid discharge apparatus including a liquid discharge head that includes a capacitive load driven by being supplied with a drive signal and discharges a liquid by driving the capacitive load, and a capacitive load drive circuit that outputs the drive signal, in which the capacitive load drive circuit includes a correction circuit that outputs a correction base drive signal obtained by correcting a base drive signal which is a base of the drive signal, a modulation circuit that outputs a modulation signal obtained by modulating the correction base drive signal, an amplification circuit that outputs an amplified modulation signal obtained by amplifying the modulation signal to a first output point, a level shift circuit that outputs a level shift amplified modulation signal obtained by level-shifting a reference potential of the amplified modulation signal to a second output point, a demodulation circuit that outputs the drive signal by demodulating the level shift amplified modulation signal, and a feedback circuit that feeds back the drive signal to the correction circuit, in which the correction circuit outputs the correction base drive signal corrected by a first correction value, in a first mode in which the level shift circuit outputs the level shift amplified modulation signal having the reference potential of the amplified modulation signal as a first potential, and outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.

According to this liquid discharge apparatus, depending on whether the level shift circuit is in the first mode in which the level shift circuit outputs the level shift amplified modulation signal having the reference potential of the amplified modulation signal as the first potential or the second mode in which the level shift circuit outputs the level shift amplified modulation signal obtained by level-shifting the reference potential of the amplified modulation signal to the second potential different from the first potential, the correction circuit corrects the base drive signal which is the base of the drive signal, and outputs the correction base drive signal. Since the drive signal is generated based on the correction base drive signal, the possibility that the signal waveform of the drive signal is distorted is reduced even when the level shift circuit transitions from the first mode to the second mode. Therefore, the waveform accuracy of the drive signal output by the capacitive load drive circuit is improved, and the discharge accuracy of the liquid in the liquid discharge apparatus is improved.

In an aspect of the liquid discharge apparatus, the level shift circuit may be in the first mode when a voltage value defined by the base drive signal is a first voltage value, and in the second mode when a voltage value defined by the base drive signal is a second voltage value higher than the first voltage value.

According to this liquid discharge apparatus, the correction circuit corrects the base drive signal, which is the base of the drive signal, depending on whether the mode is in the first mode or the second mode, and outputs the base drive signal as the correction base drive signal. Therefore, even when the mode is in the first mode in a case in which the voltage value defined by the base drive signal is the first voltage value, and even when the mode is in the second mode in a case in which the voltage value defined by the base drive signal is the second voltage value higher than the first voltage value, the possibility that the signal waveform of the drive signal is distorted is reduced. Therefore, the waveform accuracy of the drive signal output by the capacitive load drive circuit is improved, and the discharge accuracy of the liquid in the liquid discharge apparatus is improved.

In an aspect of the liquid discharge apparatus, the amplification circuit includes a first gate drive circuit that outputs a first gate signal and a second gate signal based on the modulation signal, a first transistor that has one end supplied with a first voltage signal and the other end electrically coupled to the first output point, and operates based on the first gate signal, and a second transistor that has one end electrically coupled to the first output point and the other end supplied with a second voltage signal, and operates based on the second gate signal.

In an aspect of the liquid discharge apparatus, the level shift circuit includes a bootstrap circuit that receives input of a third voltage signal and the amplified modulation signal, and outputs a fourth voltage signal corresponding to the third voltage signal and the amplified modulation signal, a second gate drive circuit that outputs a third gate signal and a fourth gate signal based on the base drive signal, a third transistor that has one end supplied with the fourth voltage signal and the other end electrically coupled to the second output point, and operates based on the third gate signal, and a fourth transistor that has one end electrically coupled to the second output point and the other end supplied with the amplified modulation signal, and operates based on the fourth gate signal.

In an aspect of the liquid discharge apparatus, the feedback circuit may include a high-pass filter.

In an aspect of the liquid discharge apparatus, the feedback circuit may include a low-pass filter.

In an aspect of the liquid discharge apparatus, the capacitive load may be a piezoelectric element.

According to another aspect of the present disclosure, there is provided a capacitive load drive circuit that includes a capacitive load to be driven by being supplied with a drive signal and outputs the drive signal to a liquid discharge head which discharges a liquid by driving the capacitive load, the circuit including a correction circuit that outputs a correction base drive signal obtained by correcting a base drive signal which is a base of the drive signal, a modulation circuit that outputs a modulation signal obtained by modulating the correction base drive signal, an amplification circuit that outputs an amplified modulation signal obtained by amplifying the modulation signal to a first output point, a level shift circuit that outputs a level shift amplified modulation signal obtained by level-shifting a reference potential of the amplified modulation signal to a second output point, a demodulation circuit that outputs the drive signal by demodulating the level shift amplified modulation signal, and a feedback circuit that feeds back the drive signal to the correction circuit, in which the correction circuit outputs the correction base drive signal corrected by a first correction value, in a first mode in which the level shift circuit outputs the level shift amplified modulation signal having the reference potential of the amplified modulation signal as a first potential, and outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.

According to this capacitive load drive circuit, depending on whether the level shift circuit is in the first mode in which the level shift circuit outputs the level shift amplified modulation signal having the reference potential of the amplified modulation signal as the first potential or the second mode in which the level shift circuit outputs the level shift amplified modulation signal obtained by level-shifting the reference potential of the amplified modulation signal to the second potential different from the first potential, the correction circuit corrects the base drive signal which is the base of the drive signal, and outputs the correction base drive signal. Since the drive signal is generated based on the correction base drive signal, the possibility that the signal waveform of the drive signal is distorted is reduced even when the level shift circuit transitions from the first mode to the second mode. Therefore, the waveform accuracy of the drive signal output by the capacitive load drive circuit is improved.

What is claimed is:

1. A liquid discharge apparatus comprising:
a liquid discharge head that includes a capacitive load driven by being supplied with a drive signal and discharges a liquid by driving the capacitive load; and
a capacitive load drive circuit that outputs the drive signal, wherein
the capacitive load drive circuit includes
a correction circuit that outputs a correction base drive signal obtained by correcting a base drive signal which is a base of the drive signal,
a modulation circuit that outputs a modulation signal obtained by modulating the correction base drive signal,
an amplification circuit that outputs an amplified modulation signal obtained by amplifying the modulation signal to a first output point,
a level shift circuit that outputs a level shift amplified modulation signal obtained by level-shifting a reference potential of the amplified modulation signal to a second output point,
a demodulation circuit that outputs the drive signal by demodulating the level shift amplified modulation signal, and
a feedback circuit that feeds back the drive signal to the correction circuit, and
the correction circuit
outputs the correction base drive signal corrected by a first correction value, in a first mode in which the level shift circuit outputs the level shift amplified modulation signal having the reference potential of the amplified modulation signal as a first potential, and
outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.

2. The liquid discharge apparatus according to claim 1, wherein
the level shift circuit is in the first mode when a voltage value defined by the base drive signal is a first voltage value, and in the second mode when a voltage value defined by the base drive signal is a second voltage value higher than the first voltage value.

3. The liquid discharge apparatus according to claim 1, wherein
the amplification circuit includes
a first gate drive circuit that outputs a first gate signal and a second gate signal based on the modulation signal,
a first transistor that has one end supplied with a first voltage signal and the other end electrically coupled to the first output point, and operates based on the first gate signal, and
a second transistor that has one end electrically coupled to the first output point and the other end supplied with a second voltage signal, and operates based on the second gate signal.

4. The liquid discharge apparatus according to claim 1, wherein
the level shift circuit includes
a bootstrap circuit that receives input of a third voltage signal and the amplified modulation signal t, and outputs a fourth voltage signal corresponding to the third voltage signal and the amplified modulation signal,
a second gate drive circuit that outputs a third gate signal and a fourth gate signal based on the base drive signal,
a third transistor that has one end supplied with the fourth voltage signal and the other end electrically coupled to the second output point, and operates based on the third gate signal, and
a fourth transistor that has one end electrically coupled to the second output point and the other end supplied with the amplified modulation signal, and operates based on the fourth gate signal.

5. The liquid discharge apparatus according to claim 1, wherein
the feedback circuit includes a high-pass filter.

6. The liquid discharge apparatus according to claim 5, wherein
the feedback circuit includes a low-pass filter.

7. The liquid discharge apparatus according to claim 1, wherein
the capacitive load is a piezoelectric element.

8. A capacitive load drive circuit that includes a capacitive load to be driven by being supplied with a drive signal and outputs the drive signal to a liquid discharge head which discharges a liquid by driving the capacitive load, the circuit comprising:
a correction circuit that outputs a correction base drive signal obtained by correcting a base drive signal which is a base of the drive signal;
a modulation circuit that outputs a modulation signal obtained by modulating the correction base drive signal;
an amplification circuit that outputs an amplified modulation signal obtained by amplifying the modulation signal to a first output point;
a level shift circuit that outputs a level shift amplified modulation signal obtained by level-shifting a reference potential of the amplified modulation signal to a second output point;
a demodulation circuit that outputs the drive signal by demodulating the level shift amplified modulation signal; and
a feedback circuit that feeds back the drive signal to the correction circuit, wherein
the correction circuit
outputs the correction base drive signal corrected by a first correction value, in a first mode in which the level shift circuit outputs the level shift amplified modulation signal having the reference potential of the amplified modulation signal as a first potential, and
outputs the correction base drive signal corrected by a second correction value different from the first correction value, in a second mode in which the level shift circuit outputs the level shift amplified modulation signal obtained by level-shifting the reference potential of the amplified modulation signal to a second potential different from the first potential.
